(19) United States
(12) Patent Application Publication
(10) Pub. No.: US 2019/0279136 A1
(43) Pub. Date: Sep. 12, 2019

(54) METHOD AND SYSTEM FOR SELECTIVE DATA VISUALIZATION AND POSTING OF SUPPLY CHAIN INFORMATION TO A BLOCKCHAIN

(71) Applicants: ALEXANDER GERSHENSON, SANTA CRUZ, CA (US); JAMES BARSIMANTOV, SANTA CRUZ, CA (US)

(72) Inventors: ALEXANDER GERSHENSON, SANTA CRUZ, CA (US); JAMES BARSIMANTOV, SANTA CRUZ, CA (US)

(21) Appl. No.: 15/913,861

(22) Filed: Mar. 6, 2018

(51) Int. Cl. G06Q 10/06; G06F 17/30

(52) U.S. Cl. CPC G06Q 10/06395; G06F 17/30283; G06F 17/30864

(57) ABSTRACT

A method and system for communicating an associated series of queries from a requester to a first system and in responses having answers to certain queries are recorded in a blockchain and answers to certain other queries are not recorded in the blockchain. Additional aspects include selectively posting answers to the blockchain; automatically posting certain answers to the blockchain; automatically not posting certain other answers to the blockchain; posting answers to the blockchain as selectively directed by another party or system as selected by an operator of the primary system; communicating replies to selected individual queries of an associated plurality of queries while alternatively or additionally posting one or more answers to individual queries to the blockchain; and/or visually rendering images of information by varying image size, hue, shape and/or intensity.

### CO-PENDING APPLICATION

The present Nonprovisional Patent Application is a Continuation Application of U.S. Nonprovisional patent application Ser. No. 14/265,291 titled “METHOD AND SYSTEM FOR SELECTIVE ACCESS TO SUPPLIER IDENTITY, PERFORMANCE AND QUALITY VALUES AND VISUAL PRESENTATION OF RELATIVE SUPPLIER PERFORMANCE VALUES” and filed on Apr. 29, 2014. The present Nonprovisional Patent Application claims the priority date of Nonprovisional patent application Ser. No. 14/265,291. Furthermore, Nonprovisional Patent application Ser. No. 14/265,291 is hereby incorporated into the present Nonprovisional Patent Application in its entirety and for all purposes.

### FIELD OF THE INVENTION

The present invention relates to communications and analyses related to evaluation of supplier performance by means of an electronic communications network. More particularly, the present invention relates to communicating and representing performance data and quality measures related to supply chain management.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

The prior art provides numerous means and methods to communicate store information related to goods, services and supply chain actions, practices and policies. Certain prior art methods employ blockchain technology as a public ledger of information related to supply chain actors, vendors, buyers and sellers, and exchanged goods and services. Yet the prior art fails to offer nuanced variations to patterns of information disclosure imposed on supply chain actors by application of blockchain technology. It is therefore an object of the method of the present invention to provide an alternative and nuanced method and system to selectively record information related to supply chain actors, operations and management with block chain technology.

Certain other prior art means and methods additionally or alternatively enable and/or include a rendering of supply chain information by means of icons on a display screen. Yet the prior art fails to offer optimal sensory aspects in visually rendering supply chain information. It is therefore an additional optional aspect of the method of the present invention to provide a system and method to enable more effective data visualization by means of information technology.

### SUMMARY AND OBJECTS OF THE INVENTION

Towards these objects and other objects that are made obvious in light of the present disclosure, a method and system are provided that enable communicating information related to supply chain information. The method of the present invention (hereinafter, “the invented blockchain method”) enables the systemized management and optionally the visual rendering of information by means of information technology.

The prior art enables posting of supply chain information to blockchains but fails to enable distinguishing between information provided in responses to information enquiries of which blockchain posting would be desirable and other information responsive to a same enquiring communication that would be not be desired or advisable to post to a blockchain. The prior art thus both creates opportunities for unintentionally publishing trade secret or otherwise sensitive or restricted information to a blockchain as well as dissuading parties concerned about undesired information disclosures from using blockchain technologies.

The invented blockchain method thereby addresses the long felt need to enable and optionally provide a more nuanced method to respond to unified requests for pluralities of information by enabling an automated or optionally semi-automated process to post some information to a blockchain as instructed by the enquiring communication, and to not post to a blockchain other information responsive to and as instructed by the same enquiring communication.

In a first preferred embodiment of the invented method, a selective blockchain posting process provides that an associated series of queries are communicated from an answer requester to a primary system whereby the primary response by selectively posting certain answers to certain queries of the associated series of queries to a blockchain and certain answers to certain other queries of the associated series of queries are not recorded in the blockchain. Alternative, optional and additional aspects of the invented method include, in isolation or combination, (a.) posting answers to the blockchain as selectively directed by the requester; (b.) posting answers to the blockchain as indicated by a specifying list of queries approved for automatic posting of corresponding answers; (c.) not posting answers to the blockchain as indicated by an additional list of queries disapproved for posting of their corresponding answers; (d.) posting answers to the blockchain as selectively directed by another party or system as automatically and/or as selected by an operator of the primary system; and/or (e.) communicating via an electronic communications network replies to selected individual queries of an associated plurality of queries while alternatively or additionally posting one or more answers to individual queries of the associated plurality of queries to a blockchain.

In other alternative, optional and additional aspects of the invented method include, in isolation or combination, visually rendering images of information by varying image size, hue, shape and/or intensity.

The invented blockchain method advances the art of information distribution by powerfully enhancing the techniques of public ledger design and practice to enable buyers and suppliers of goods and services to offer unlimited and timely public access to previously unattainable granularities of informational detail of the processes, outcomes and human and ecological impacts of commercial, industrial, military and governmental activities. In distinction from the prior art, by providing systematized, contemporaneous and ubiquitous public disclosure, the invented blockchain method empowers the public and citizenry to build knowledge-based confidence in their understanding of the workings, malleability, unintended consequences, and desired and undesired outcomes of the commercial and public sectors of human society, while enabling selective disclosures of information that answer a same enquiring communication whereby information approved for posting to a blockchain is selected from information not to be posted on a blockchain or otherwise held confidential.

The invented blockchain method inventively advances beyond the prior art public ledger technology to enable wide access via multi-channel modes to information necessary to best intellectually nourish and accurately inform consumers and voters. The invented blockchain method inventively creates, in distinction from the prior art, a uniquely profound and society-wide informational network that will provide critical and detailed social reality data, economic activity and attending full-spectrum impact data, factory data, supplier data, multi tier data, and consumer facing data; this network of human knowledge will form a knowledge base nexus merging the metrics and public understandings of our shared physical environment, environmental realities, governance dynamics, and other globally and locally relevant performance metrics. By inventively providing systemized access to new levels of operational knowledge concerning the actual and immediate functioning of the global economy and our diverse societies, the invented blockchain method creates new avenues of application and development of the systems, methods and products of augmented reality, social media information sharing, and gamification to drive greater consumer clarity, enable more holistic socially responsible purchasing decisions and expand the effectiveness of human society to chart its course forward through multiple landscapes of ecological, ethical and security risks.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### INCORPORATION BY REFERENCE

All publications, patents, and patent applications mentioned in this specification are herein incorporated by reference to the same extent as if each individual publication, patent, or patent application was specifically and individually indicated to be incorporated by reference. U.S. Pat. No. 9,569,771 (Lesavich, et al.; issued Feb. 14, 2017) entitled “Method and system for storage and retrieval of blockchain blocks using galois fields”; U.S. Pat. No. 9,774,578 (Ateniese, et al.; issued Sep. 26, 2017) entitled “Distributed key secret for rewritable blockchain”; U.S. Pat. No. 9,785,369 (Ateniese, et al.; issued Oct. 10, 2017) entitled “Multiple-link blockchain”; and U.S. Pat. No. 9,898,782 (Winklevoss, et al.; issued Feb. 20, 2018) entitled “Systems, methods, and program products for operating exchange traded products holding digital math-based assets” are incorporated herein by reference in their entirety and for all purposes.

### BRIEF DESCRIPTION OF THE FIGURES

These, and further features of the invention, may be better understood with reference to the accompanying specification and drawings depicting the preferred embodiment, in which:

FIG. 1A is a network diagram depicting an environment and structure of a first preferred embodiment of the invented service.

FIG. 1B presents block diagrams of invented query records.

FIG. 1C is a block diagram of an exemplary invented scorecard record.

FIG. 1D is a block diagram of an exemplary invented submitted scorecard record that includes answers provided by a responding user of the respondent system of FIG. 1A.

FIG. 1E is a block diagram of a database management system of the server of FIG. 1A.

FIG. 1F is a block diagram of a buyer profile maintained in the database management system of the server of FIG. 1E.

FIG. 1G is a block diagram of a supplier profile maintained in the database management system of the server of FIG. 1E.

FIG. 1H is a block diagram of a buyer database management system of the enquirer system of FIG. 1A.

FIG. 1I is a block diagram of a supplier database management system of the respondent system of FIG. 1A.

FIG. 2 is a software flowchart of the enquirer system of FIG. 1A forming a new scorecard record as directed by a first user of the enquirer system.

FIG. 3 is a software flowchart of the server of FIG. 1A responding to the enquirer system of FIG. 1A and processing a scorecard query process in communication with the respondent system of FIG. 1A.

FIG. 4 is a representation of the respondent system of FIG. 1A responding to receipt of query data N as directed by a responding user.

FIG. 5A is a block diagram of an exemplary scorecard request message.

FIG. 5B is a block diagram of an exemplary score card message.

FIG. 5C is a block diagram of an exemplary response message.

FIG. 5D is a block diagram of an exemplary reply message

FIG. 6 is a flowchart of a comparison process wherein an enquiring party of FIG. 1A may compare query and scorecard answers of a known supplier with other unidentified suppliers without disclosing the identities of the unidentified suppliers.

FIG. 7A is a block diagram of an exemplary comparison request message.

FIG. 7B is a block diagram of a pseudonym table

FIG. 7C is a block diagram of an exemplary comparison data message.

FIG. 8 is a software flowchart of interaction of the enquirer system with the server of FIG. 1A and the enquiring user.

FIG. 9A is a block diagram of a contact request message of FIG. 8.

FIG. 9B is a block diagram of the supplier response message of FIG. 8.

Referring now generally to the Figures and particularly to FIG. 10, FIG. 10 is a representation of the enquirer system of FIG. 1A accessing selected data of the supplier profile record as enabled by the server of FIG. 1A by application of the pseudonym table of FIG. 7B and without revealing the identity of suppliers.

FIG. 11 is a flowchart of the respondent system in interaction with the server of FIG. 1A in conducting a comparison of its answers to answers provided by other suppliers of a specified industry to the same queries.

FIG. 12A is a block diagram of an exemplary self assessment message of the process of FIG. 11.

FIG. 12B is a block diagram of the second pseudonym table of the process of FIG. 1 as maintained by the server of FIG. 1A.

FIG. 12C is a block diagram of the exemplary self assessment data message of steps 11.06 and 11.08 of FIG. 11 and as sent to the respondent system of FIG. 1A from the server of FIG. 1A.

FIG. 13 is a block diagram that presents additional aspects of the network of FIG. 1A, wherein the network is shown to additionally comprise a blockchain network.

FIG. 14 is a process chart of a first preferred embodiment of the invented blockchain method;

FIG. 15 is a block diagram of a first blockchain scorecard message generated in step 14.04 of the method of FIG. 14.

FIG. 16 is a block diagram of a first authorization table as applied by a supplier system of FIG. 1A or FIG. 15 in step 14.06 through step 14.20 of the method of FIG. 14.

FIG. 17 is a block diagram of a first reply message as generated by a supplier system of FIG. 1A or FIG. 15 in step 14.08 of the method of FIG. 14.

FIG. 18 is a block diagram of a first blockchain post message as generated by a supplier system of FIG. 1A or FIG. 15 in step 14.12 of the method of FIG. 14.

FIG. 19 is a block diagram of a first subset query message as generated by a supplier system of FIG. 1A or FIG. 15 in step 14.18 of the method of FIG. 14.

FIG. 20 is a block diagram of a first query subset reply message as generated by a supplier system of FIG. 1A or FIG. 15 in step 14.22 of the method of FIG. 14.

FIG. 21 is a block diagram of a first subset blockchain post message as generated by a supplier system of FIG. 1A or FIG. 15 in step 14.26 of the method of FIG. 14.

FIG. 22 is a flowchart of operations of a supplier system in responding to and processing a blockchain scorecard message.

FIG. 23 is a flowchart of additional operations of a supplier system in preparing a blockchain posting message.

FIG. 24 is a flowchart of optional aspects of preparing a data visualization in accordance with the invented blockchain method.

### DETAILED DESCRIPTION

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims.

Methods recited herein may be carried out in any order of the recited events which is logically possible, as well as the recited order of events.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative”.

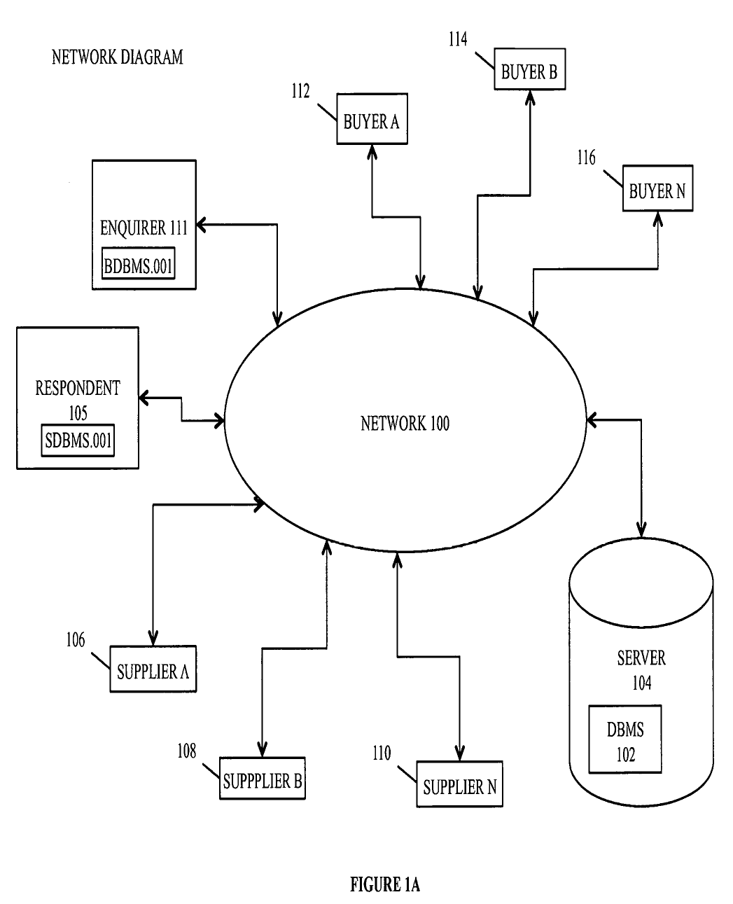

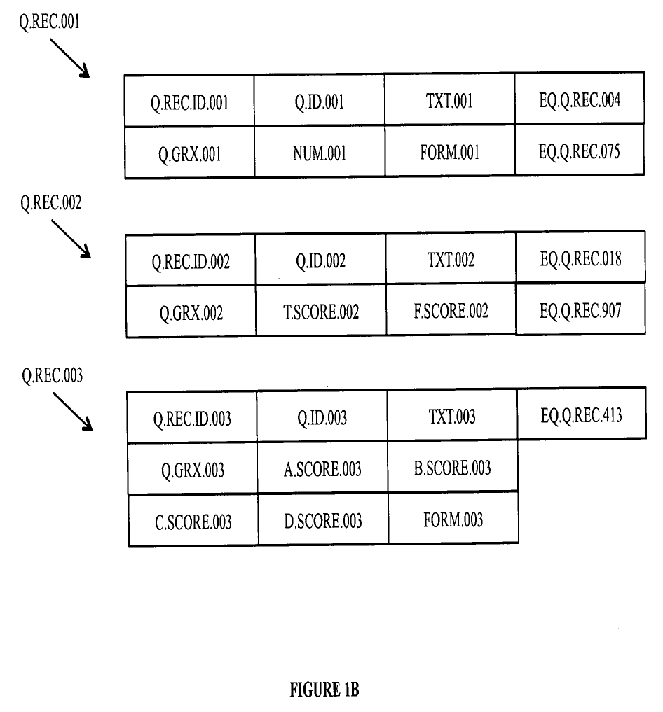

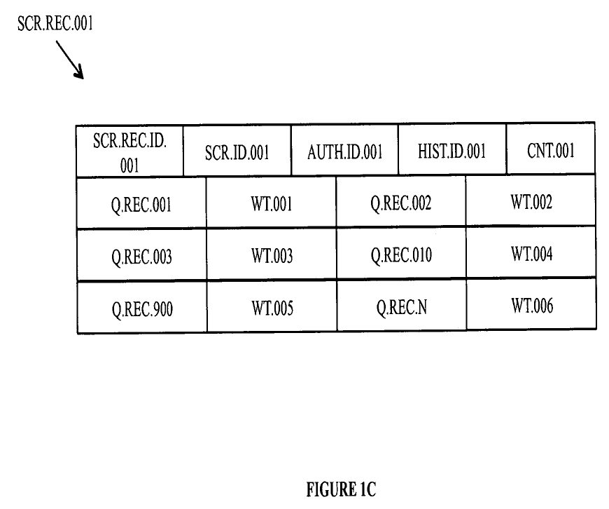

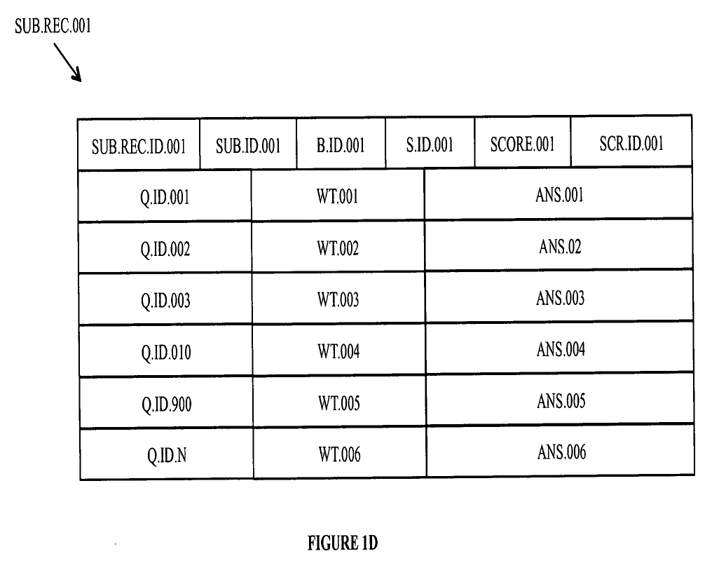

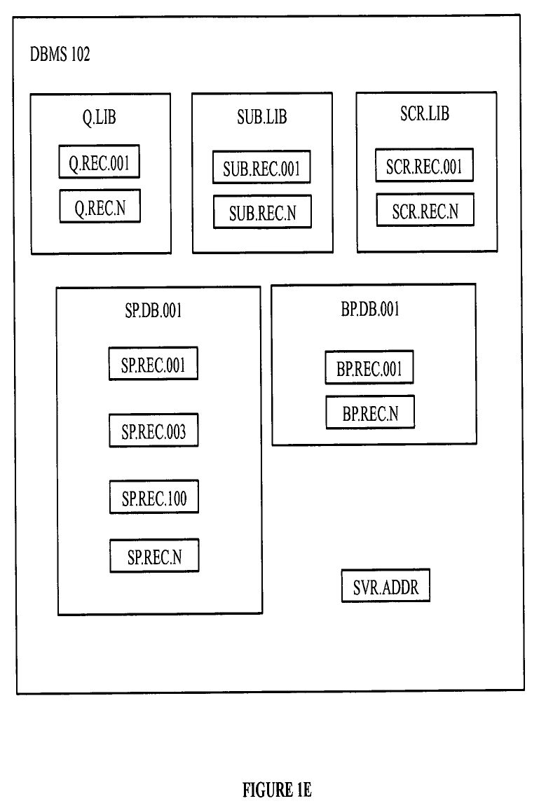

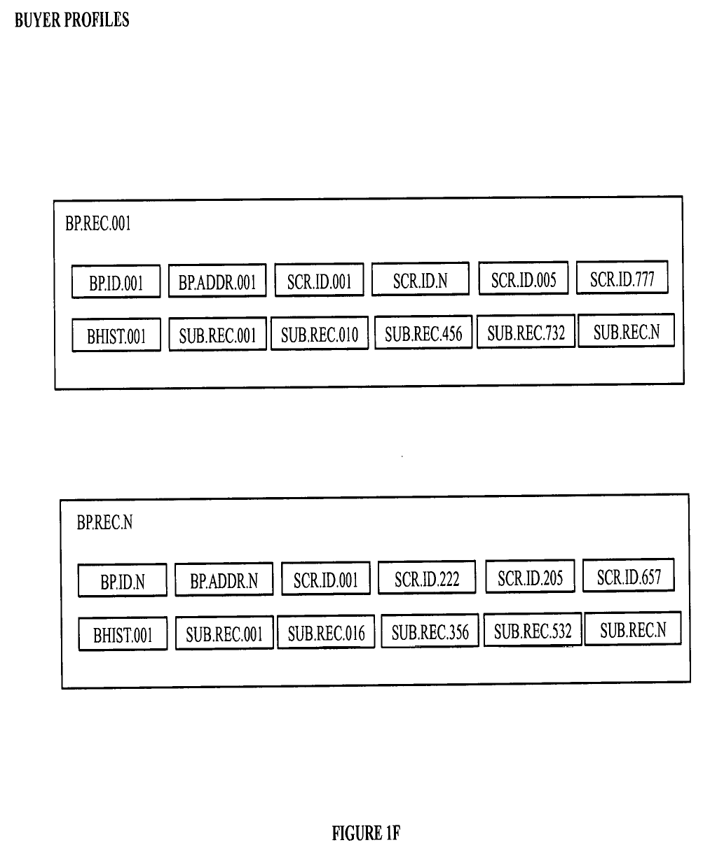

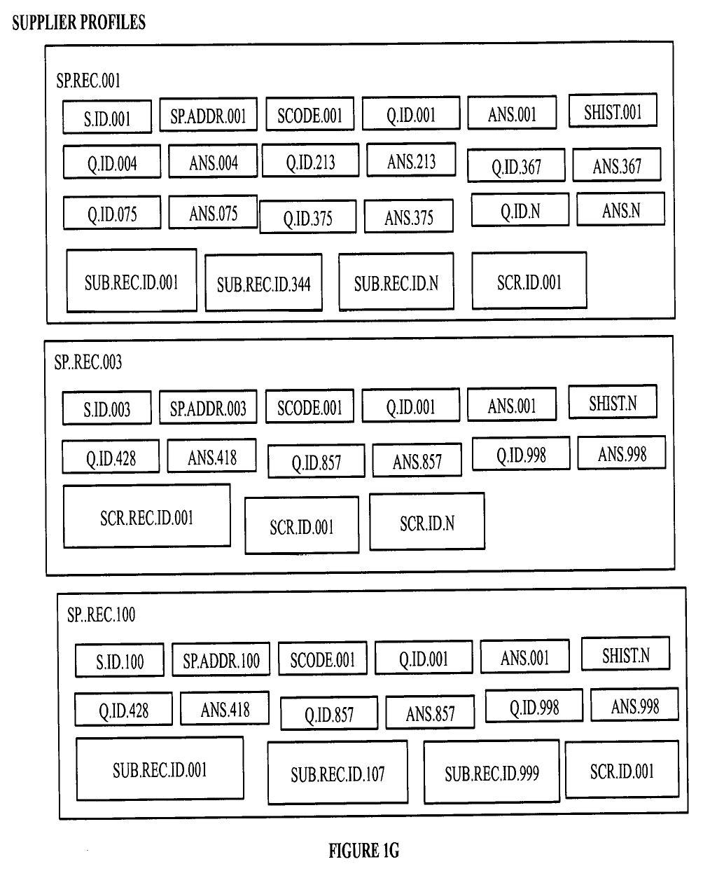

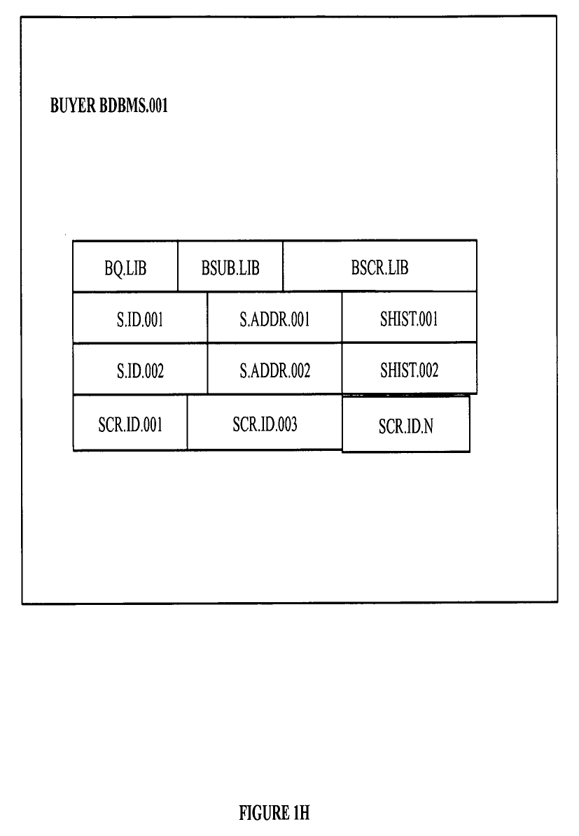

Referring now generally to the Figures and particularly to FIG. 1, FIG. 1 presents an electronic communications network 100 (hereinafter, “the network 100”) that optionally comprises the Internet and/or one or more telephony networks. The network 100 bi-directionally communicatively couples a query and scorecard database management system 102 of a system server 104, a plurality of the respondent system and the supplier systems 106, 108 & 110 (hereinafter, “supplier systems” 105-110) and a plurality of enquirer systems 111, 112, 114 & 116 (hereinafter, “buyer systems” 111-116). It is understood that the example scenarios presented herein of buyers as enquirers and suppliers as respondents are offered for the purpose of clarity and not intended as limitations of the scope of the invented method.

As discussed in reference to the Figures generally, the query and scorecard database server 104 (hereinafter, “the server 104) is managed in the invented method to enable selective access to query records Q.REC.01-Q.REC.N, scorecard records SCR.REC.01-SCR.REC.N, submitted scorecard records SUB.REC.01-SUB.REC.N derived from submitted answers to queries of scorecard records SCR.REC.001-SCR.REC.N, supplier/respondent identifiers S.ID.01-S.ID.N, buyer/enquirer identifiers B.ID.01-B.ID.N, and additional information useful in performing assessments, rankings and comparisons of answers to queries and respondent performance.

Each supplier system 106-1101 preferably maintains a library of previously answered query records Q.REC.001-Q.REC.N, scorecard records SCR.REC.001-SCR.REC.N, and submitted scorecard records SUB.REC.001-SUB.REC.N, whereby a given supplier may determine if a newly received query has been previously answered. The supplier may thus be enabled to rely on selecting and communicating a locally accessible answer in response to a previously received query of a same query record Q.REC.001-Q.REC.N. This inventive feature may be particularly valuable in large organizations wherein numerous departments may be receiving the same query from numerous buyers or other enquirers, whereby the efficiency of the invented service of determining on a remote, external server on behalf of a supplier's agent if an accurate, valid and current answer to the instant query has been made available and authorized for response by one or more individual responding employees of the organization.

Examples of embodiments of these server 104 and systems 105 through 116 would include bundled software and hardware computer products such as (a.) a network-communications enabled THINKSTATION WORKSTATION™ notebook computer marketed by Lenovo, Inc. of Morrisville, N.C.; (b.) a NIVEUS 5200 computer workstation marketed by Penguin Computing of Fremont, Calif. and running a LINUX™ operating system or a UNIX™ operating system; (c.) a network-communications enabled personal computer configured for running a WINDOWS™ operating system as marketed by Microsoft Corporation of Redmond, Wash.; (d.) a MACBOOK PRO™ personal computer as marketed by Apple, Inc. of Cupertino, Calif.; (e.) an IPAD™ tablet computer as marketed by Apple, Inc. of Cupertino, Calif.; (f) an IPHONE™ cellular telephone as marketed by Apple, Inc. of Cupertino, Calif.; (g.) an HTC TITAN II™ cellular telephone as marketed by AT&T, Inc. of Dallas, Tex. and running a WINDOWS 7™ operating system as marketed by Microsoft Corporation of Redmond, Wash.; (h.) a GALAXY NEXUS™ smart phone as marketed by Samsung Group of Seoul, Republic of Korea and running an ANDROID™ operating system; (i.) a TOUGHPAD™ tablet computer as marketed by Panasonic Corporation of Kadoma, Osaka, Japan and running an ANDROID™ operating system as marketed by Google, Inc. of Mountain View, Calif.; or (j.) other suitable mobile electronic device, wireless communications device, computational system or electronic communications device known in the art.

Referring now generally to the Figures a first preferred embodiment (hereinafter, “the first method”) of the invented method provides for a query library Q.LIB maintained by the server 104 of query records Q.REC.01-Q.REC.N that each contain an expression of a query. As shown at least in FIG. 1B, a first query record Q.REC.001 provides a first query that is directed toward generating a numeric response. A first text data TXT.001 includes data that can be rendered as a human-readable first query. An optional first graphics data Q.GRX.001 includes image data that may be rendered in combination with or in alternate place of the first text data TXT.001 to express the human-readable first query. The exemplary first query record Q.REC.001 also includes pointers to queries Q.REC.004 & Q.REC.075, wherein the EQ designation in the first query record indicates that these other queries have equivalent answers which may be provided to an enquirer in the invented process of responding to and answering a scorecard or a query.

A first normalizing value NUM.001 may be applied to a numeric answer provided by the respondent to adjust the numeric answer to normalize the scoring process. A first formula FORM.001 may be applied to derive a normalized numeric answer by applying the first normalizing value NUM.001 to a received respondent answer to the first query. An example derivation of a normalized numeric answer might be, in accordance with a logic of the first formula FORM.001, to divide a respondent's numeric input by a normalizing value NUM.001 of 100.

The first method further provides a second query record Q.REC.002 that is directed toward a second query structured as a TRUE/FALSE query, wherein the expected respondent replies are limited to TRUE, FALSE, and NULL. A second query record Q.REC.002 includes a second text data TXT.002 that that can be rendered as a human-readable second query. An optional second graphics data Q.GRX.002 includes image data that may be rendered in combination with or in alternate place of the second text data TXT.002 to express the human-readable second query. The exemplary first query record Q.REC.001 also includes pointers to queries Q.REC.018 & Q.REC.907,

A true score datum T.SCORE.002 provides a numeric value associated with receipt of a query reply recognized as a TRUE value by the server 104. A false score datum F. SCORE.002 provides a numeric value associated with receipt of a query reply recognized as a FALSE value by the server 104. For example, a respondent selection of a TRUE value may add a numeric value of one to a total score of a scorecard SCR.001-SCR.N comprising the exemplary second query record Q.REC.002, whereas a respondent selection of a TRUE value may add a numeric value of zero to the instant total score.

The first method further provides a third query record Q.REC.003 that is directed toward a third query structured as a multiple choice query, wherein the expected respondent replies are limited to a set of four answer choices. It is understood that the exemplary four choices is chosen for the purpose of clarity of explanation and is not meant as limiting and required number of choices enabled by the invented method.

A third query record Q.REC.003 includes a third text data TXT.003 that includes data that can be rendered as a human-readable multiple-choice third query. An optional third graphics data Q.GRX.003 includes image data that may be rendered in combination with or in alternate place of the third text data TXT.003 to express the human-readable multiple-choice third query. A first multiple choice selection score datum A. SCORE.003 provides a numeric value associated by the server with a respondent selection of a first A choice of the multiple choice third query. A second multiple choice selection score datum B.SCORE.003 provides a numeric value associated by the server 104 with a respondent selection of a second B choice of the multiple choice third query. A third multiple choice selection score datum C.SCORE.003 provides a numeric value associated by the server 104 with a respondent selection of a third C choice of the multiple choice third query. A fourth multiple choice selection score datum D.SCORE.003 provides a numeric value associated by the server 104 with a respondent selection of a fourth D choice of the multiple choice third query. For example, a respondent selection of the A choice may add a numeric value of three to a total score of a scorecard SCR.001-SCR.N comprising the exemplary second query record Q.REC.002, a respondent selection of the B choice may add a numeric value of zero to the instant total score, a respondent selection of the C choice may add a numeric value of eight to the instant total score, and a respondent selection of the D choice may add a numeric value of five to the instant total score.

Referring now generally to the Figures and particularly to FIG. 1C, FIG. 1C illustrates an exemplary first scorecard record SCR.REC.001 of a scorecard library maintained by the server 104. The first scorecard record SCR.REC.001 includes a first scorecard record identifier SCR.REC.ID.001, a first scorecard identifier SCORE.ID.001 a plurality of query records Q.REC.001-Q.REC.N, an optional notation of a first author data AUTH.001 that identifies an original or identified author of the first scorecard record SCR.REC.001, an optional history of use data HIST.001 of the first scorecard record SCR.REC.001, and a first counter CTR.001 that specifies the number of query records Q.REC.001-Q.REC.N included in the first scorecard record SCR.REC.001. It is understood that the exemplary count of six query records Q.REC.001 of the exemplary first scorecard record SRC.REC.001 choices is chosen for the purpose of clarity of explanation and is not meant as limiting nor specifying a required number of queries to be included within a scorecard record SRC.REC.001-SRC.REC.N of the first method.

The first scorecard record SCR.REC.001 further optionally includes a plurality of weighting factors WT.001-WR.N that are each separately and individually associated with an individual query record Q.REC.001-Q.REC.N that may be applied in generating a total score of a respondent's submitted scorecard SCR.SUB.001-SCR.SUB.N.

It is understood that a scorecard record SCR.REC.001-SCR.REC.N may include a single query text data Q.TXT.001-Q.TXT.N and/or a single query graphics data Q.GRX.001-Q.GRX.N.

Referring now generally to the Figures and particularly to FIG. 1D, FIG. 1D illustrates an exemplary first submitted scorecard record SUB.REC.001 of the submitted scorecard library SUB.LIB maintained by the server 104. The exemplary first submitted scorecard SUB.REC.001 includes a plurality of respondent submitted answers ANS.001-ANS.N to individual queries as derived from the associated query records Q.REC.001-Q.REC.N identified by a plurality of query identifiers Q.ID.001-Q.ID.N included within the first submitted scorecard record SUB.REC.001-SUB.REC.N.

The first submitted scorecard record SUB.REC.001 further includes a first submitted scorecard record identifier SUB.REC.ID.001, a submitted scorecard identifier SUB.ID.001, a respondent identifier R.ID, a first score SCORE.001 derived from the answers ANS.001-ANS.006 and the first score record identifier SCR.ID.001 of an exemplary first scorecard record SRC.REC.001 from which the query records Q.REC.001-Q.REC.N were referenced and/or sourced. More particularly first scorecard identifier SCR.ID.001 is the identifier of the scorecard record SCR.REC.01-SCR.REC.N from which the queries associated with the exemplary first submitted scorecard record SUB.REC.001 were specified.

The exemplary first submitted scorecard record SUB.REC.001 represents a digitized and archived set of answers received as a result of a respondent reviewing the queries specified by the first scorecard record SCR.REC.001 of FIG. 1C and thereto providing answers ANS.001-ANS.006 to the server 104.

Referring now generally to the Figures and particularly to FIG. 1E, FIG. 1E illustrates the scorecard database management system 102 (hereinafter, “the DBMS” 102) of the server 104, that includes the query library Q.LIB of the query records Q.REC.001-Q.REC.N, the scorecard record library SCR.LIB of scorecard records SCR.REC.001-SCR.REC.N that each preferably contain one or more query records Q.REC.001-Q.REC.N, the submitted scorecard library SUB.LIB of submitted scorecard records SUB.REC.001-SUB.REC.N that each preferably contain answers to queries that are referenced by query records Q.REC.001-Q.REC.N, a buyer profile database BP.DB, and a supplier profile database SP.DB.

Referring now generally to the Figures and particularly to FIG. 1E and FIG. 1F, FIG. 1F presents an exemplary first buyer profile record BP.REC.001 and an exemplary Nth buyer profile record BP.REC.N of an exemplary first buyer profile database BP.DB.001, wherein the first buyer profile record BP.REC.001 includes a first buyer identifier BP.ID.001, a first buyer network address BP.ADDR.001 of the first enquirer system 111, a listing of scorecard identifiers SCR.ID.001-SCR.ID.N previously authored, accessed or used by the buyer entity referenced by the buyer entity identified by the first buyer identifier BP.ID.001, a listing of submitted scorecard records SUB.REC.001-SUB.REC.N previously accessed by the buyer entity referenced by the first buyer identifier BP.ID.001, and a first buyer historical data BHIST.001 that records buyer interactions with the invented system 100.

Referring now generally to the Figures and particularly to FIG. 1E and FIG. 1G, the exemplary first supplier profile database SP.DB.001 includes an exemplary first supplier profile record SP.REC.001 and an exemplary Nth supplier profile record SP.REC.N. The exemplary first supplier profile record SP.REC.001 includes a first supplier identifier S.ID.001, a first supplier network address SP.ADDR.001, a first supplier category code SCODE.001, and a listing of query identifiers Q.ID.001-Q.ID.N and associated supplier answers ANS.001-ANS.N of queries previously answered by the supplier entity identified by the first supplier identifier S.ID.001. The first supplier category code SCODE.001 and/or one or more supplier category codes SCODE.001-SCODE.N of additional supplier profiles records SP.REC.002-SP.REC.N may be a supplier category code in conformance with an industrial classification system, such as the Standard Industrial Classification System (hereinafter “SIC”) or the North American Industry Classification System (hereinafter, “NAICS”) issued, published and maintained by the United States Government.

One or more supplier profiles records SP.REC.001-S.REC.N may further optionally include a supplier historical data SHIST.001-SHIST.N of supplier interaction with the invented system 100 that optionally includes scorecard identifiers SCR.ID.001-SCR.ID.N and/or submitted scorecard identifiers SUB.ID.001-SUB.SCR related to queries and answers previously addressed and generated by the supplier entity identified by the supplier identifier S.ID.001-S.ID.N of the comprising supplier profile record SP.REC.001-SP.REC.N.

Referring now generally to the Figures and particularly to FIG. 1H, FIG. 1H is a representation of an exemplary first buyer database management system BDBMS.001 of the first enquirer system 111. The first buyer database management system BDBMS.001 (hereinafter, “first BDBMS” BDBMS.001) includes a first buyer query library BQ.LIB.001, a first buyer scorecard library BSCR.LIB.001 and a first buyer submitted scorecard library BSUB.LIB.001. The first buyer query library BQ.LIB.001 includes a one or more query identifiers Q.ID.001-Q.ID.N previously applied by the first enquirer system 11 land optionally data harvested from query records Q.REC.001-Q.REC.N. The first buyer scorecard library preferably BSCR.LIB.001 includes one or more scorecard identifiers SCR.ID.001-SCR.ID.N and data harvested from scorecard records SCR.REC.001-SCD.REC.N previously authored, accessed or applied by the first enquirer system 111. The first buyer submitted scorecard library BSUB.LIB.001 includes the submitted scorecard identifiers SUB.ID.001-SUB.ID.N and data harvested from submitted scorecard records SUB.REC.001-SUB.REC.N previously accessed by the first enquirer system 111.

The first buyer BDBMS BDBMS.001 further optionally includes a listing of supplier identifiers S.ID.001-S.ID.N each preferably paired and associated with at least one unique supplier network address S.ADDR.001-S.ADDR.N of the respondent system 105 or a supplier system 106, 108 & 110.

Referring now generally to the Figures and particularly to FIG. 1I, FIG. 1I is a representation of an exemplary first supplier database management system BDMS.001 of the respondent system 105. The first supplier database management system SDBMS.001 (hereinafter, “first SDBMS” SDBMS.001) includes a first supplier query library SQ.LIB.001, a first supplier scorecard library SSCR.LIB.001 and a first supplier submitted scorecard library SSUB.LIB.001. The first supplier query library SQ.LIB.001 includes a one or more query identifiers Q.ID.001-Q.ID.N each associated with one specific answer ANS.001-ANS.N previously supplied by the entity associated with the first supplier identifier S.ID.001 and optionally additional data harvested from query records Q.REC.001-Q.REC.N. It is understood that one or more query identifiers Q.ID.001-Q,ID.N may be associated with more than one previously submitted answers ANS.001-ANS.N and an associated time date stamp TDS.001-TDS.N of each previously submitted answers ANS.001-ANS.N.

The first supplier scorecard library preferably SSCR.LIB.001 includes one or more scorecard identifiers SCR.ID.001-SCR.ID.N and optional data harvested from scorecard records SCR.REC.001-SCD.REC.N previously authored, accessed or applied by the respondent system 105. The first supplier submitted scorecard library SSUB.LIB.001 includes the submitted scorecard identifiers SUB.ID.001-SUB.ID.N and data harvested from submitted scorecard records SUB.REC.001-SUB.REC.N previously submitted by the respondent system 105 to the server 104 and./or the first enquirer system 111 or the buyer systems 112, 114 & 116.

The first supplier SDBMS SDBMS.001 further optionally includes a listing of buyer identifiers B.ID.001-B.ID.N each preferably paired and associated with at least one unique buyer network address BP.ADDR.001-BP.ADDR.N of an enquirer system 111 or a buyer system 112, 114 & 1116.

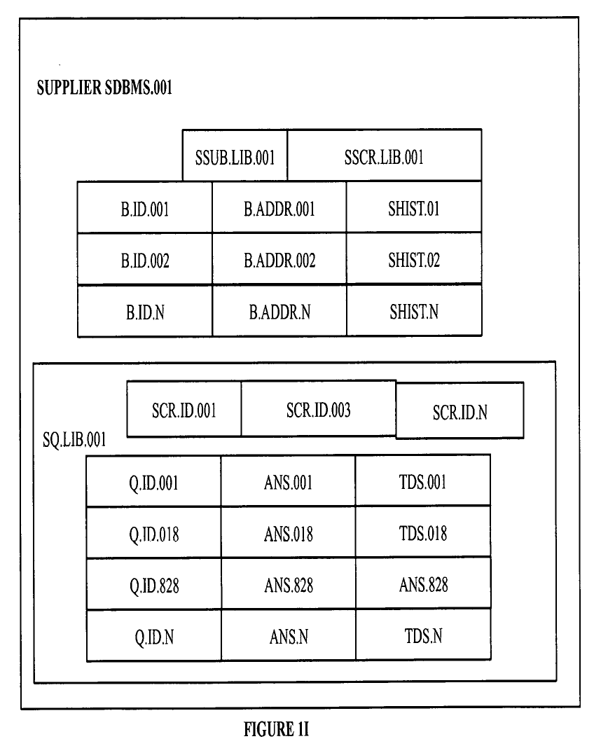

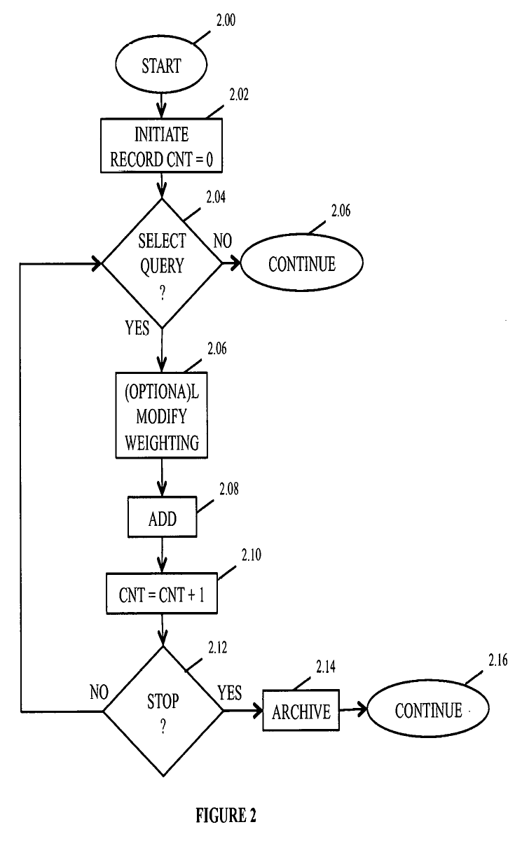

Referring now generally to the Figures and particularly to FIG. 2, FIG. 2 is a representation of the first enquirer system 111 as directed by first system user in populating a new scorecard record SRC.REC.001-SRC.REC.N. In step 2.02 the first enquirer system 111 set a counter equal to zero and in the loop of steps 2.04 through 2.12 the first user directs the first enquirer system 111 to select a query record Q.REC.001-Q.REC.N (step 2.04) optionally modify the weighting WT.001-WT.N of the last selected query record Q.REC.001-Q.REC.N in step 11.06 from a default weighting, and add the last selected query record Q.REC.001-Q.REC.N to the new scorecard record SRC.REC.001-SRC.REC.N in step 2.10. The first enquirer system 111 increments the counter CNT in step 2.10, and as directed by the first user proceeds onto either (a.) another performance of the loop of steps 2.04 through 2.12, or to archive the new scorecard record SRC.REC.001-SRC.REC.N, including the current value of the counter CNT, at both the first enquirer system 111 and the server 104 in step 2.14. It is understood that a scorecard record SCR.REC.001-SCR.REC.N may include only one query text data Q.TXT.001-Q.TXT.N and/or only one query graphics data Q.GRX.001-Q.GRX.N.

The first enquirer system 111 then proceeds from step 2.14 to step 2.16 and to perform alternate computational operations.

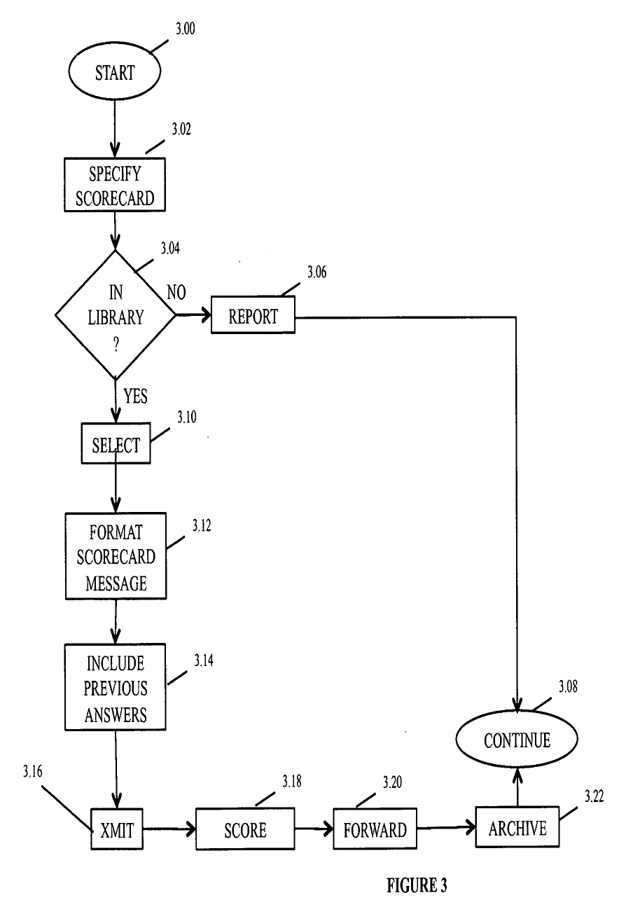

Referring now generally to the Figures and particularly to FIG. 3, FIG. 3 is a representation of the server 104 engaging with the network 100 in generating a submitted scorecard record SUB.REC.001-SUB.REC.N. In step 3.02 the server 104 receives an exemplary scorecard request message R. SCR.MSG that includes a supplier identifier S.ID.001-S.ID.N of the first enquirer system 111 and specifies a scorecard record SCR.REC.001-SCR.N. The server 104 determines in step 3.04 if the scorecard record SCR.REC.001-SCR.REC.N identified in step 3.02 is in the scorecard library SCR.LIB.

If the referenced scorecard record SCR.REC.001-SCR.REC.N is not found in step 3.04, the server 104 reports this failure to the first enquirer system 111 in step 3.06 and proceeds on to other computational operations of step 3.08. In the alternative, if the referenced scorecard record SCR.REC.001-SCR.REC.N is found in step 3.04, the server 104 selects the referenced scorecard record SCR.REC.001-SCR.REC.N in step 3.10 and finds the supplier network address S.ADDR.001-S.ADDR.N associated with the supplier identifier S.ID.001-S.ID.N specified scorecard request message R.SCR.MSG received in step 3.02.

The server 103 next formats a scorecard message SCR.MSG in step 3.12 wherein the exemplary scorecard message SCR.MSG is addressed to the buyer system 105-110 identified in the scorecard request message R.SCR.MSG of step 3.02. The server 104 further populates the SCR.MSG with a query text data Q.TXT.001-Q.TXT.N and/or a query graphics data Q.GRX.001-Q.GRX.N of the selected scorecard record SCR.REC.001-SCR.REC.N. It is understood that a scorecard record SCR.REC.001-SCR.REC.N may include only one query text data Q.TXT.001-Q.TXT.N and/or only one query graphics data Q.GRX.001-Q.GRX.N.

In step 3.14 the server 104 searches the supplier profile database SP.DB.001 for any instances of the supplier identified in the scorecard request message R.SCR.MSG having previous answers to any query encoded into the query records Q.REC.001-Q.REC.N included in the selected scorecard record SCR.REC.001-SCR.REC.N, including answers to the queries of equivalent query records Q.REC.001-Q.REC.N. Any relevant previously provided answers noted in the supplier profile database SP.DB.001 as having been supplied by the supplier identified in the scorecard request message R.SCR.MSG are added to the SCR.MSG in step 3.14 and in association with its associated query text data Q.TXT.001-Q.TXT.N and/or query graphics data Q.GRX.001-Q.GRX.N.

The scorecard message SCR.MSG is then transmitted in step 3.16 to the to the buyer system 105-110 identified in the scorecard request message R.SCR.MSG of step 3.02.

When and if a submittal response message RESP.MSG is received by the server 104 in step 3.18, the server 104 generates a submittal scorecard record SUB.REC.001-SUB.REC.N and calculates a score SCORE of the newly generated submittal scorecard record SUB.REC.001-SUB.REC.N. The server 104 then transmits the received answers ANS.001-ANS.N of the response message RESP.MSG the score SCORE of the newly generated submittal scorecard record SUB.REC.001-SUB.REC.N to the first enquirer system 111 in a reply message REPLY.MSG in step 3.10. The server next archives the newly generated scorecard record SUB.REC.001-SUB.REC.N in step 3.22. The server 104 proceeds from step 3.22 on to perform other computation operations of step 3.08.

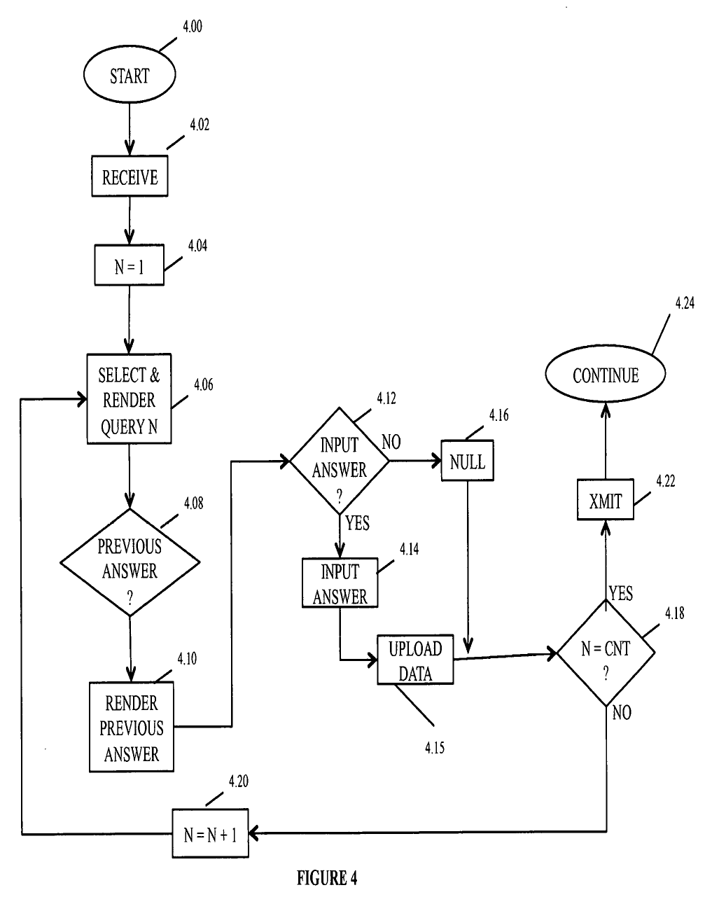

Referring now generally to the Figures and particularly to FIG. 4, FIG. 4 is a representation of the respondent system 105 responding to receipt of the query data Q.TXT.001-Q.TXT.N & Q.GRX.001-GRX.N of the exemplary scorecard message SCR.MSG as directed by a responding user. In step 4.02 the respondent system 105 detects a receipt of a query count CNT and a set of query data Q.TXT.001-Q.TXT.N & Q.GRX.001-GRX.N and exemplary previously provided answers ANS.001 ANS.018 as provided in the exemplary scorecard message SCR.MSG. The respondent system 105 sets a loop counter n to be equal to a one value and the selects and renders the first query text data Q.TXT.001 and the first query graphics data Q.GRX.001 of the exemplary scorecard message in step 4.06. Previous answer ANS.001 associated with first query text data Q.TXT.001 is detected in step 4.08 and is additionally rendered by the respondent system 105 in step 4.10. The responding user the directs the respondent system 105 in step 4.12 to (a.) accept and input the previously supplied answer ANS.001, (b.) accept and input a different answer, or (c.) accept and input a null answer. The answer input in step 4.14 is recorded into the exemplary response message RESP.MSG and in optional step 4.15 a responding user may upload additional data RESP.DATA,001-RESP.DATA.N into and a scorecard message SCR.MSG, such as images, video data, textual documents, numeric data, and formatted documents such as in conformance with WORD™ word processing system as marketed by Microsoft Corporation, or the PDF™ document format as marketed by Adobe Corporation. In alternative step 4.16, the responding user directs the respondent system 105 to enter a no answer, i.e., a null response. In step 4.18 the respondent system 105 determines that the loop counter is not equal to the count CNT of queries. The loop counter N is then incremented in step 4.20.

In a second iteration of the loop of steps 4.06 through 4.20 renders the second query text data Q.TXT.002 and the second query graphics data Q.GRX.002 in step 4.06, and furthers renders the equivalent answer ANS.018 in the second execution of step 4.10. The responding user then directs the respondent system 105 in the second execution of step 4.12 to (a.) accept and input the previously supplied answer ANS.018, (b.) accept and input a different answer, or (c.) accept and input a null answer. The respondent system 105 iterates through the loop of steps 4.06 through 4.20 until each query text data Q.TXT.001-Q.TXT.N and graphics data Q.GRX.001-Q.GRX.N of the exemplary scorecard message SCR.MSG has been rendered by the respondent system 105 and responded to by the responding user. As directed by the responding user, the respondent system 105 then transmits the populated response message RESP.MSG to the server 104 in step 4.22 and proceeds on to perform alternate computational operations on step 4.24.

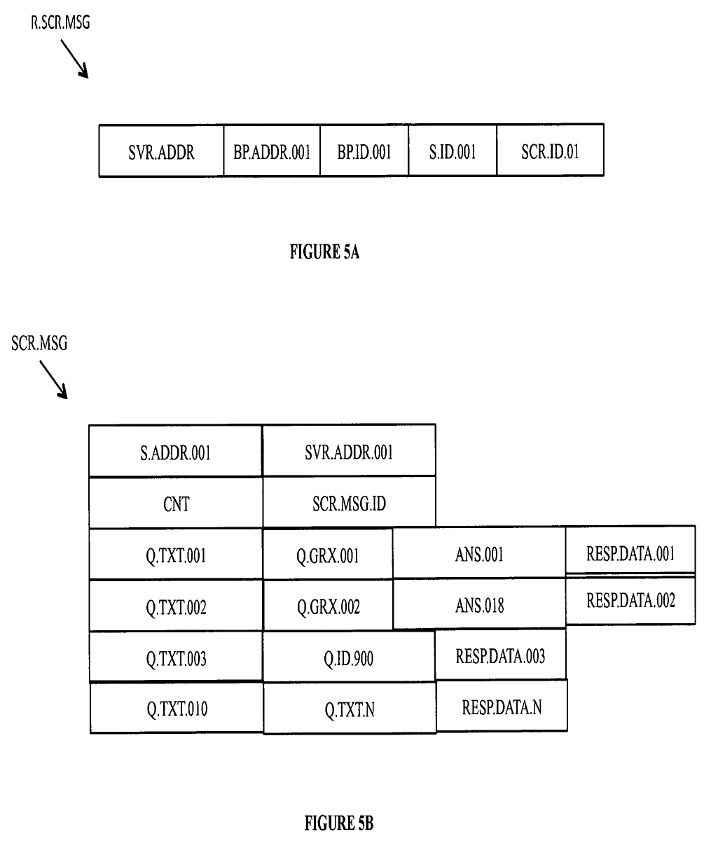

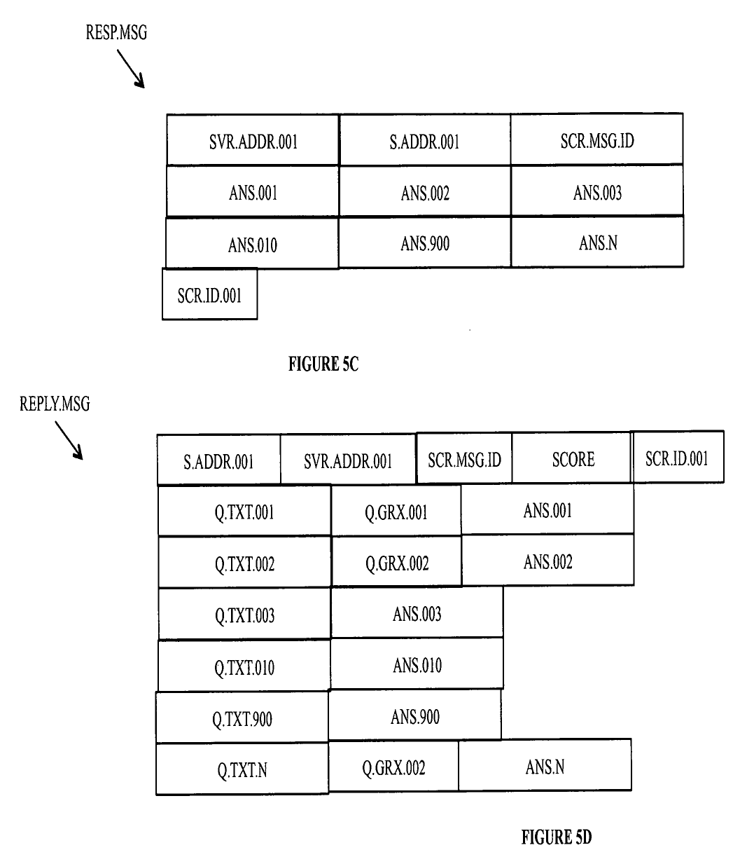

Referring now generally to the Figures and particularly to FIG. 5A, FIG. 5A is a block diagram of the exemplary scorecard request message R.SCR.MSG. The scorecard request message R.SCR.MSG includes a network address of the server 104 SVR.ADDR.001 as a destination address, the network address BP.ADDR.001 of the enquiring system 111 as the sender address, the identifier of the enquiring entity BP.ID.001, the identifier of the exemplary first supplier SID.001 and the identifier of the exemplary first scorecard SCRID.001.

Referring now generally to the Figures and particularly to FIG. 5B, FIG. 5B is a block diagram of the exemplary score card message SCR.MSG. The scorecard message SCR.MSG includes the network address S.ADDR.001 of the first respondent system 105 as the destination address, a network address of the server 104 SVR.ADDR.001 as a sender address, a query counter CNT equaling the number of queries provided in the score card message SCR.MSG (six in this case of the first exemplary scorecard record SCR.REC.001), a unique scorecard message identifier SCR.MSG.ID, and the query text data Q.TXT.001-Q.TXT.N and optionally graphics data Q.GRX.N.

Referring now generally to the Figures and particularly to FIG. 5C, FIG. 5C is a block diagram of the response message RESP.MSG. The response message RSP.MSG includes the network address SVR.ADDR of the server 104 as the destination address, the network address the respondent system S.ADDR.001 as a sender address, the unique scorecard message identifier SCR.MSG.ID of the related scorecard message SCR.MSG, and six individual answers ANS.001-ANS.N to the first queries of the first exemplary scorecard record SCR.REC.001. It is noted the responding user in this instance of the exemplary response message RESP.MSG input the previously supplied first answer ANS.001 but elected to not input an equivalent alternate answer ANS.018 associated with the second query text data Q.TXT.002 but in the alternative input a new second answer ANS.002.

Referring now generally to the Figures and particularly to FIG. 5D, FIG. 5D is a block diagram of the exemplary reply message REPLY.MSG of step 3.20 of the process of FIG. 3. The exemplary REPLY.MSG includes the network address BP.ADDR.001 of the first enquirer system 111 as the destination address, the network address SVR.ADDR.001 of the server 104 as the sender address, the score SCORE calculated in step 3.18, the relevant unique scorecard message identifier SCR.MSG.ID, the query text data Q.TXT.001-Q.TXT.N, graphics data Q.GRX.N and answers ANS.001-ANS.N of the associated exemplary scorecard message and response message RESP.MSG. The enquiring user may thus render the answers to the queries as intended in step 3.02.

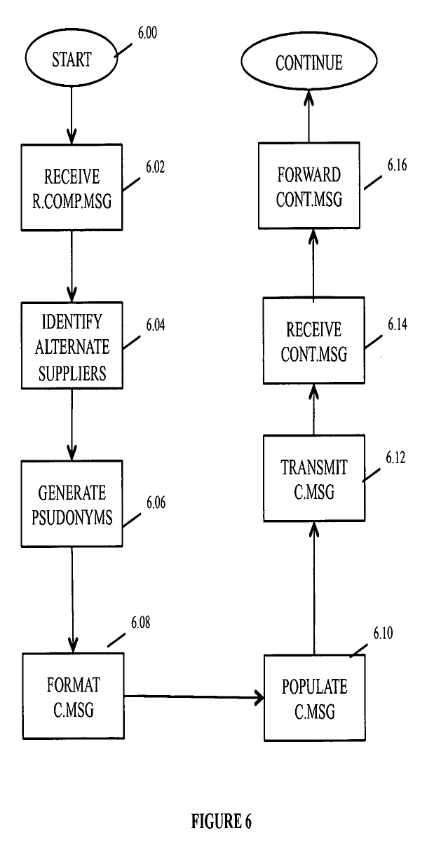

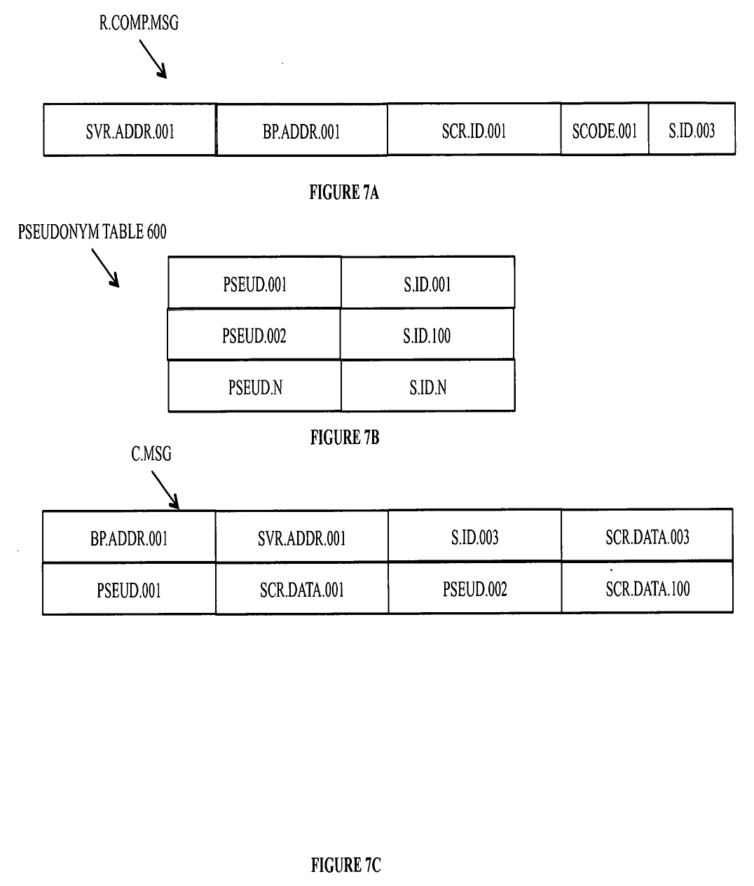

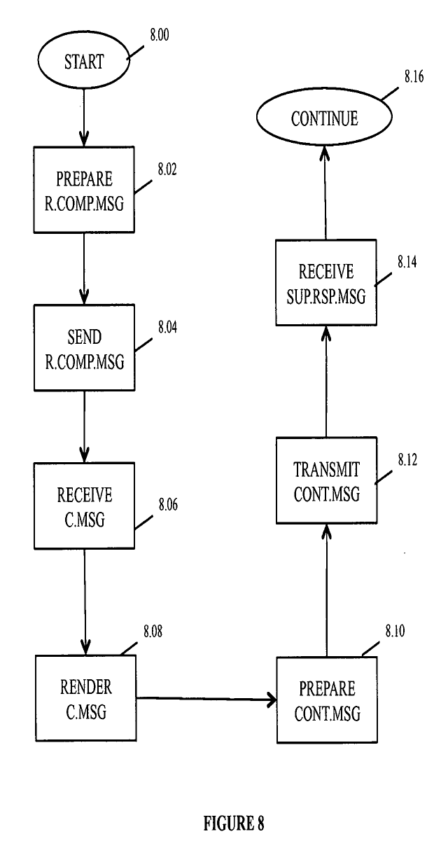

Referring now generally to the Figures and particularly to FIG. 6, FIG. 6 is a flowchart of a comparison process wherein an enquiring party may compare query and scorecard answers of a known supplier with other unidentified suppliers without disclosing the identities of the unidentified suppliers. In step 6.02 the server 104 receives an exemplary compare request message R.COMP.MSG from the first enquirer system 111 that identifies a known supplier with a third supplier identifier S.ID.003, and includes the exemplary first scorecard record identifier SCR.REC.ID.001, and provides an exemplary first supplier category code SCODE.001. In step 6.04 the server 104 searches the supplier profile database SP.DB.001 and looks for any supplier profile records SP.REC.001-SP.REC.N that reference both the first scorecard record identifier SCR.REC.ID.001 and the first supplier category code SCODE.001. In step 6.06 the server 104 generates distinguishable pseudonyms PSEUD.001& PSEUD.002 for each supplier identifier S.ID.001 & S.ID.100 determined to be associated with both the first scorecard record identifier SCR.REC.ID.001 and the first supplier category code SCODE.001. The association of each distinguishable pseudonym PSEUD.001& PSEUD.002 with each individual supplier identifier S.ID.001 & S.ID.100 is maintained in a pseudonym table 600 of FIG. 7B.

In step 6.08 the server 104 harvests query data Q.TXT.001-Q.TXT.N & Q.GRX-GRX.N FROM each submitted scorecard record SUB.REC.001-SUB.REC.N that are both (a.) associated with and derived in view of the first scorecard record SCR.REC.001, and (b.) associated with the suppliers identified by the pseudonyms of step 6.06. An exemplary comparison data message C.MSG is formatted in step 6.10 and populated with the pseudonyms of step 6.06 and the data harvested in step 6.08. The comparison data message C.MSG is sent to the first enquirer system 111 in step 6.12.

In optional step 6.14 the server 104 receives a contact request message CONT.MSG from the first enquirer system 111 and forwards on the contact request message CONT.MSG to the supplier system 105-110 indicated by a pseudonym PSEUD.001 & PSEUD.002 provided in the contact request message CONT.MSG. The server 104 then proceeds from step 6.16 to step 6.18 and to perform alternate computational operations.

Referring now generally to the Figures and particularly to FIG. 7A, FIG. 7A is a block diagram of the exemplary comparison request message R.COMP.MSG of step 6.02. The comparison request message R.COMP.MSG includes the server network address SVR.ADDR of the network server 104 as the destination address and the first enquirer system network address BP.ADDR.001 as the sender address. The comparison request message R.COMP.MSG further contains the third supplier identifier S.ID.003, the exemplary first scorecard identifier SCR.ID.001, and provides an exemplary first supplier category code SCODE.001.

Referring now generally to the Figures and particularly to FIG. 7B, FIG. 7B is a block diagram of the pseudonym table 600 of step 606 as maintained by the server 104 and that associates pseudonyms PSEUD.001 & PSEUD.002 with assigned supplier identifiers S.ID.001 & S.ID.100.

Referring now generally to the Figures and particularly to FIG. 7C, FIG. 7C is a block diagram of the exemplary comparison data message C.MSG of steps 6.08 through 6.12 and as sent to the first enquirer system 111 from the server 104. The first pseudonym PSEUD.001 is associated by the server 104 with a first scorecard data SCR.DATA.001 and a second pseudonym PSEUD.002 is associated by the server with a second scorecard data SCR.DATA.100. The third scorecard data SCR.DATA.003 is associated with data extracted from a submitted scorecard record SUB.REC.001-SUB.REC.N that was previously provided by the supplier identified by the third supplier identifier S.ID.003.

Referring now generally to the Figures and particularly to FIG. 8, FIG. 8 is a software flowchart of interaction of the first enquirer system 111 and the enquiring user with the server 104. In step 8.02 the first enquirer system 111 formats and populates the comparison request message R.COMP.MSG and sends the comparison request message R.COMP.MSG to the server 104 in step 8.04. The first enquirer system 111 receives the comparison message C.MSG from the server 104 in step 8.06 and visually renders data of the comparison message C.MSG in step 8.08. In step 8.10 the first enquirer system 111, as directed by the enquiring user, prepares and populates a contact request message CON.MSG that specifies the pseudonym PSEUD.100 of a supplier with whom the enquiring user desires to communicate. The first enquirer system 111 may receive a supplier response message SUP.RSP.MSG from the relevant supplier associated with the pseudonym PSEUD.100 in step 8.14 included in the contact request message CON.MSG of step 8.10.

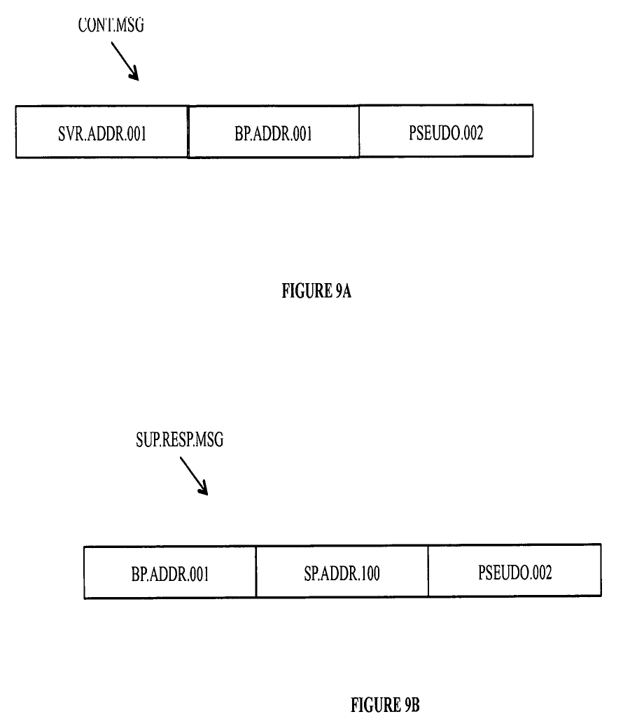

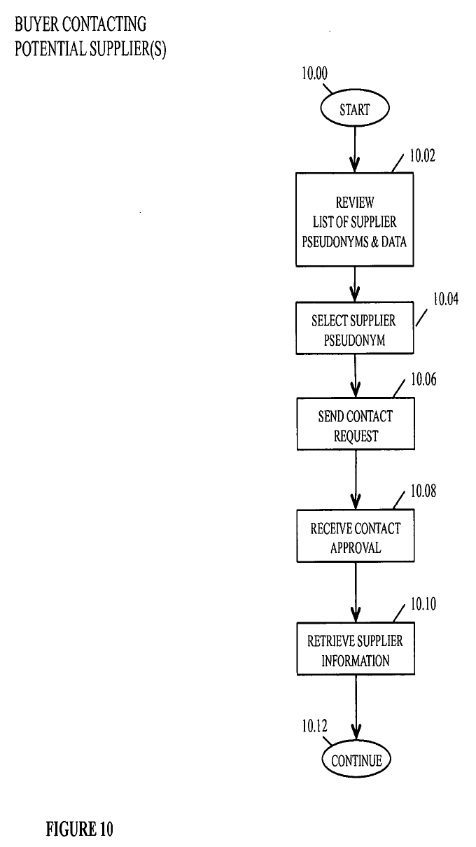

Referring now generally to the Figures and particularly to FIG. 9A, FIG. 9A is a block diagram of the contact request message CONT.MSG of step 8.10. The contact request message CONT.MSG includes the server network address SVR.ADDR as the destination address, the enquiring system network address BP.ADDR.001 as the sender address, and the selected second pseudonym PSEUD.002.

Referring now generally to the Figures and particularly to FIG. 9B, FIG. 9B is a block diagram of the supplier response message SUP.RSP.MSG of step 8.14. The supplier response message SUP.RSP.MSG includes the enquiring system network address BP.ADDR.001 as the destination address, the supplier network address SP.ADDR.100 of the RESPONDING SUPPLIER, and the selected second pseudonym PSEUD.002. Upon receipt of the supplier response message SUP.RSP.MSG by the enquiring system 111, the enquiring user may directly communicate with the responding supplier.

Referring now generally to the Figures and particularly to FIG. 10, FIG. 10 is a representation of the first enquirer system 111 accessing selected data of the supplier profile records SP.REC.001-SP.REC.N as enabled by the server 104 by application of the pseudonym table 600 and without revealing the identity of suppliers. The enquire system 111 selects a pseudonym PSEUD.001-PSEUD.N in step 10.04 and sends a relevant second contact request CONT.MSG.002 to the server 104 and specifying the Nth pseudonym PSEUD.N in step 10.06. The first enquirer system 111 receives a contact approval in step 10.08 and is then enabled by the server 104 in step 10.10 to retrieve data from the supplier profile database SP.DB.001 and other information related to the Nth supplier.

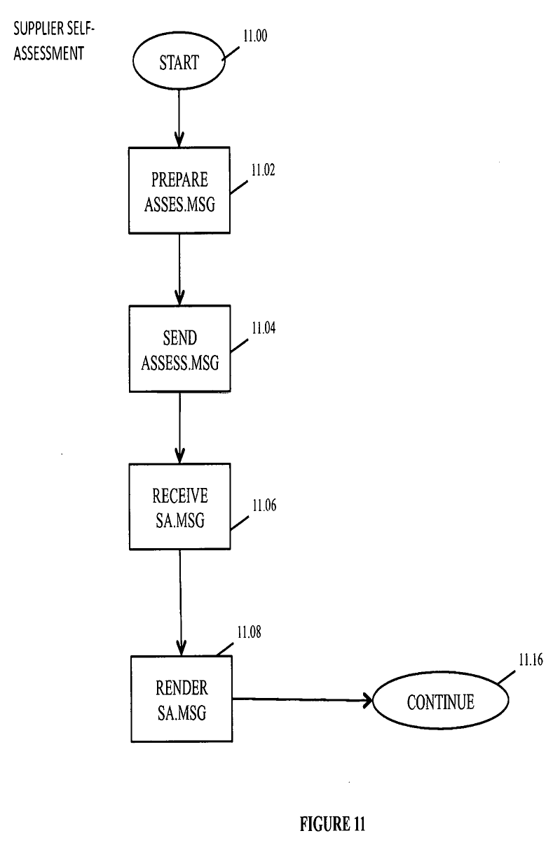

Referring now generally to the Figures and particularly to FIG. 11, FIG. 11 is a flowchart of the respondent system in interaction with the server 104 in conducting a comparison of its answers ANS.001-ANS.N to answers provided by other suppliers of a specified industry to the same queries. In step 11.02 the respondent system 105 prepares the assessment request message ASSESS.MSG of step 11.02 and sends the assessment request message ASSESS.MSG in step 11.04. The respondent system 105 receives a self assessment data message SA.MSG in step 11.06 and in step 11.08 renders the data provided. The respondent system 105 proceeds from step 11.08 to step 11.10 and to perform alternate computational operations.

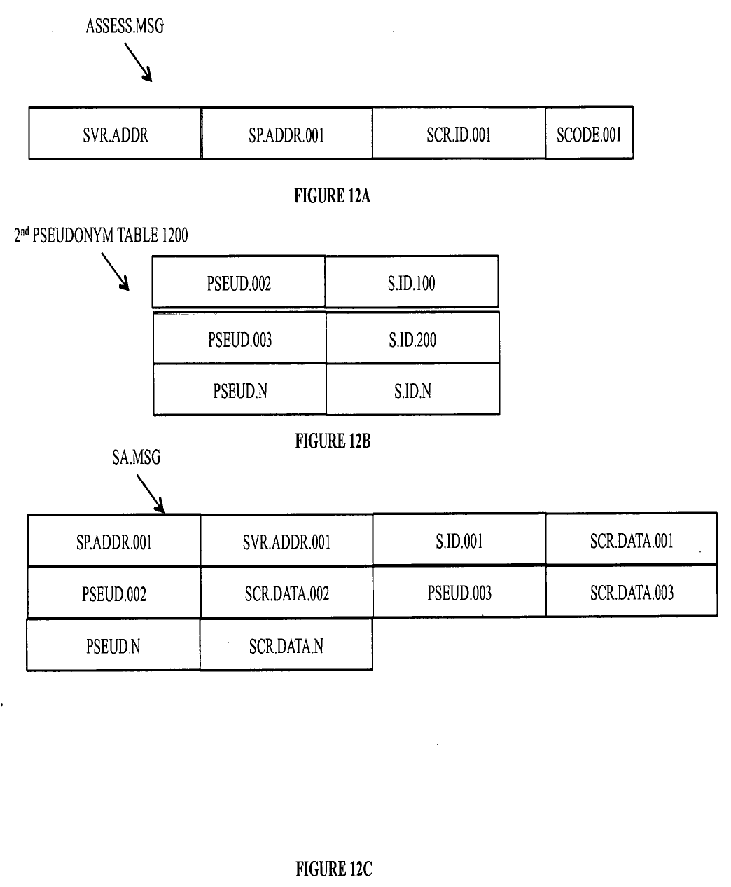

Referring now generally to the Figures and particularly to FIG. 12A, FIG. 12A is a block diagram of the exemplary self assessment message ASSESS.MSG of step 11.02 addressed to the server 104 at the server network address SVR.ADDR.001. The respondent system network address is included as the sender address SP.ADDR.001, as is the first scorecard identifier SCR.ID.001 and first supplier category code SCODE.001 are included in the self assessment message ASSESS.MSG.

Referring now generally to the Figures and particularly to FIG. 12B, FIG. 12B is a block diagram of the second pseudonym table 1200 as maintained by the server 104 and that individually and separately associates pseudonyms PSEUD.002, PSEUD.003 & PSEUD.N with assigned supplier identifiers S.ID.100, S.ID.200 & S.ID.N. It is understood that the pseudonyms PSEUD.002, PSEUD.003 & PSEUD.N and the SECOND pseudonym table 1200 are non-persistent and are preferably used within only one instance to relate to any particular entity, server 104, system 105-116, or data structure.

Referring now generally to the Figures and particularly to FIG. 12C, FIG. 12C is a block diagram of the exemplary self assessment data message SA.MSG of steps 11.06 and 11.08 and as sent to the respondent system 105 from the server 104. The self assessment data message SA.MSG includes the respondent system network address BP.ADDR.001 as the destination address and the server network address SVR.ADDR as the sender address.

The self assessment data message SA.MSG includes data related to the respondent system 105 and in association with the specified scorecard identifier, e.g., the exemplary first scorecard identifier SCR.ID.001. A nonpersistent first pseudonym PSEUD.002 is associated with a first scorecard data SCR.DATA.100, a second nonpersistent pseudonym PSEUD.003 is associated with a second scorecard data SCR.DATA.20, and another Nth pseudonym PSEUD.N is associated with an Nth scorecard data SCR.DATA.N. It is understood in preparing the self assessment data record SA.MSG the server 104 follows the processes steps 6.04 and 6.06 wherein the server 104 searches the supplier profile database SP.DB.001 and looks for and selects only from supplier profile records SP.REC.001-SP.REC.N that reference both the first scorecard record identifier SCR.REC.ID.001 and the first supplier category code SCODE.001. It is understood that the pseudonyms PSEUD.001 & PSEUD.002 and the pseudonym table 600 are non-persistent and are preferably used within only one instance to relate to any particular entity, server 104, system 105-116, or data structure.

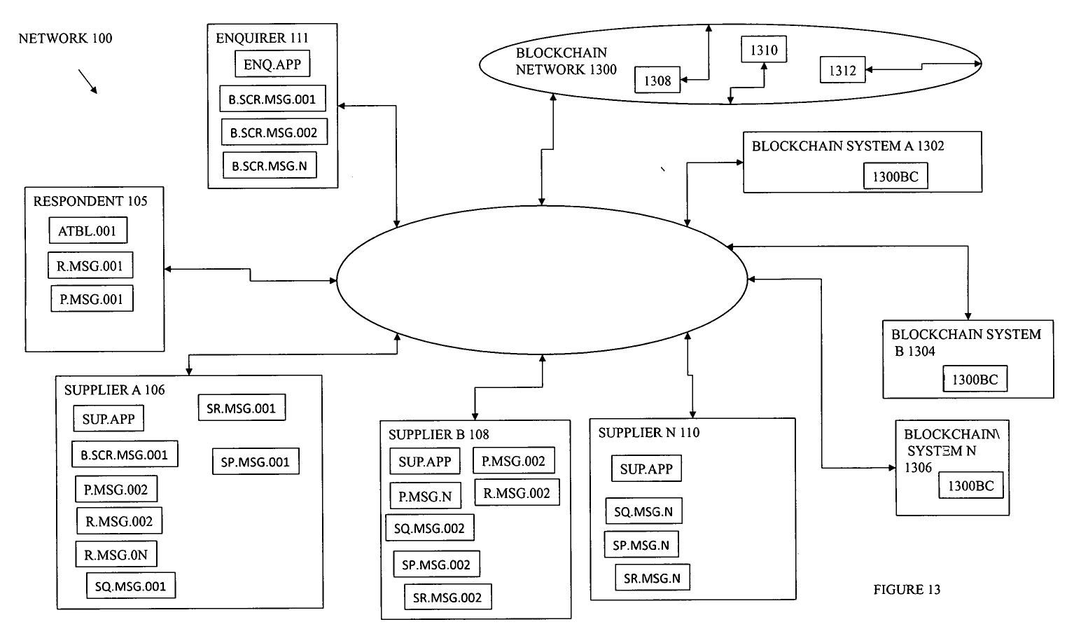

Referring now generally to the Figures and particularly to FIG. 13, FIG. 13 presents additional aspects of the invented method in bi-directional communications via the network 100, wherein the network 100 is shown to additionally comprise a blockchain network 1300. The blockchain network 1300 includes a plurality blockchain systems A through N 1302-1312 that each maintain an instance of a same blockchain 1300BC. A selection of the plurality blockchain systems A through N 1302-1306 are indicated to be directly bi-directional communicatively coupled with the network 100 as well as comprised within the blockchain network 1300.

The network 100 bi-directionally communicatively couples blockchain network 1300 with the DBMS 102, the system server 104, the plurality of supplier systems 105-110 and the plurality of enquirer systems 111, 112, 114 & 116. It is understood that the example scenarios presented herein of communications among blockchain network 1300 with the DBMS 102, the system server 104, the plurality of supplier systems 105-110 and the plurality of enquirer systems 111, 112, 114 & 116 are offered for the purpose of clarity of explanation of the scope and embodiments of the invented method and are not intended as limitations of the scope of the invented method.

An enquirer software application ENQ.APP of each enquirer system 111, 112, 114 & 116 enables the hosting enquirer system 111, 112, 114 & 116 to perform relevant each aspect of the invented method as presented herein. A supplier software application SUP.APP of each supplier system 105-110 enables the hosting supplier system 105-110 to perform each relevant aspect of the invented method as presented herein.

It is understood the network 100 and its elements 1300-1312 and bi-directionally coupled network systems 105-116 establish a multi-tier supply channel communications network wherein any one system 105-1312 may alternately and simultaneously present as a supplier, contractor, subcontractor or provider of goods and services to any other network system 105-1312 in a tiered, sequential, hierarchical or multi-echelon supplier-buyer network.

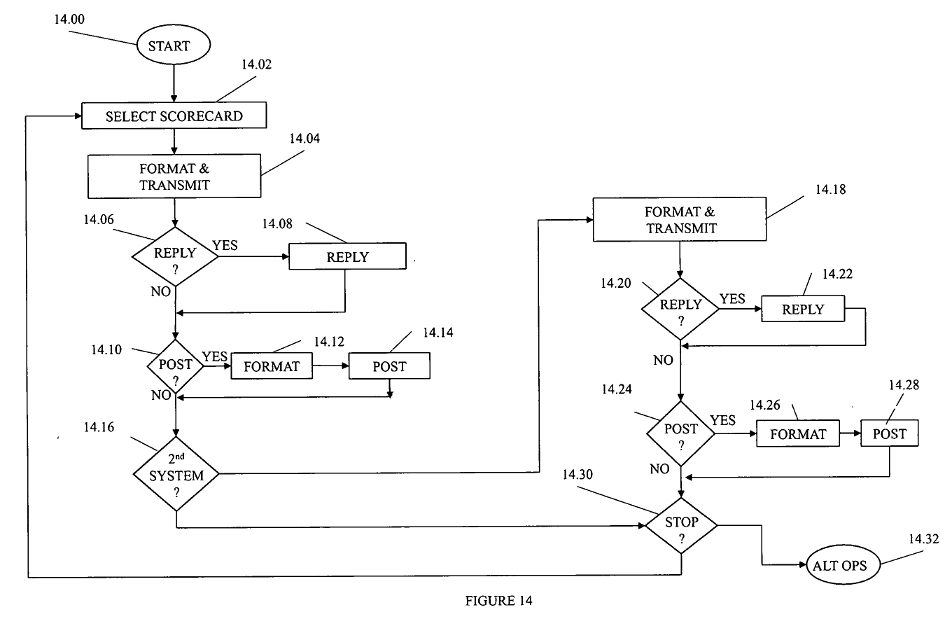

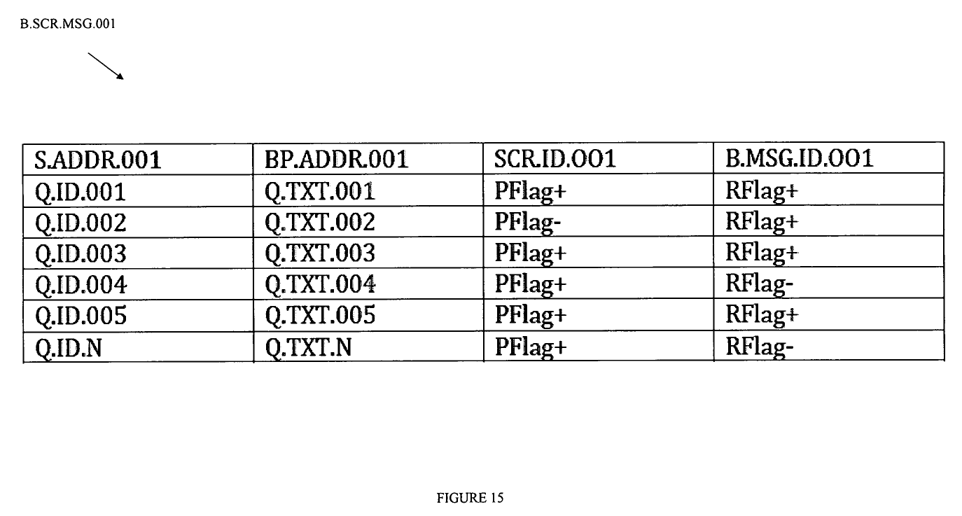

Referring now generally to the Figures and particularly to FIG. 14, FIG. 14 is a process diagram of a first preferred embodiment of the invented selective blockchain posting method (hereinafter, “the first BC method”). In step 14.00 the network 100 enables communication among the servers 102-116 & 1303-1306 and the blockchain network 1300. In step 14.02 the first enquirer system 111 selects a scorecard SCR.001-SCR.N and in step 14.04 the first enquirer system 111 formats, populates and transmits an exemplary first blockchain scorecard message B.SCR.MSG containing a plurality of question identifiers Q.ID.001-Q.ID.N and question texts Q.TXT.001-Q.TXT.N of the selected scorecard SCR.001-SCR.N and addresses the blockchain scorecard message B.SCR.MSG to an exemplary selected first respondent system 105.

The addressee of the blockchain scorecard message B.SCR.MSG will be referred to hereinafter as the “primary system” for the sake of clarity of explanation, and the first respondent system 105 will be selected as the primary system 105 in the explanation of the preferred embodiments of the present invented blockchain posting method also for the sake of clarity of explanation. It is understood that one or more the blockchain scorecard messages B.SCR.MSG.001-B.SCR.MSG.N include (a.) instructions to the recipient system 105-110 to post certain information to the blockchain 1300BC in response to receipt of the instant blockchain scorecard message B.SCR.MSG.001-B.SCR.MSG.N, and (b.) additional instructions to not post information to the blockchain 1300BC in response to receipt of the instant blockchain scorecard message B.SCR.MSG.001-B.SCR.MSG.N.

The respondent system 105 (hereinafter, “primary system” 105) receives the blockchain scorecard message B.SCR.MSG in step 14.06 and determines whether to issue a reply message of step 14.08 wherein answers to one, some or all of questions of the blockchain scorecard message B.SCR.MSG are sent in to the first enquirer system 111 or optionally to other systems via the network 100.

In step 14.10 the primary system 105 determines whether the blockchain scorecard message B.SCR.MSG instructs the primary system 105 to post one or more answers to questions contained in or specified by the blockchain scorecard message B.SCR.MSG to the blockchain instances 1300BC as stored within the blockchain servers 1302-1312. In step 14.12 the primary server 105 formats an exemplary first posting message P.MSG.001 addressed to at least one blockchain server 1302-1312 and populates the posting message with selected answers, wherein some portion of the content of the posting message P.MSG.001 is digitally signed with a private key of unique private-public key pair. In step 14.14 the primary server 105 transmits the posting message P.MSG.001 to at least one blockchain server 1302-1312.

In step 14.16 the primary server 105 determines whether one or more questions of the exemplary first blockchain scorecard message B.SCR.MSG.001 examined in step 14.16 shall be forwarded to another supplier system 106-110 in a subset query message SQ.MSG.001-SQ.MSG.N to generate and secure an additional answer or answers. When the primary server 105 determines that one or more questions of the blockchain scorecard message B.SCR.MSG examined in step 14.16 shall be forwarded to another supplier system 106-110 to secure one or more answers, the primary server 105 proceeds from step 14.16 to step 14.18 and formats, populates and sends and the additional exemplary first query subset query message SQ.MSG.001 to a selected supplier system 106-110. For the sake of clarity of explanation, the second supplier system 106 shall be referred to in discussion of steps 14.20 through 14.28.

The second supplier system 106 receives the query subset message SQ.MSG.001 in step 14.20 and determines whether to issue a reply message of step 14.22 wherein answers to one, some or all of questions of the query subset message SQ.MSG.001 are sent in to the first enquirer system 111 or optionally to other systems via the network 100. It is understood that query information, e.g., query identifiers Q.ID.001-Q.ID.N and query text Q.TXT.001-Q.TXT.N, of the query subset message SQ.MSG.001 are all derived from one or more originating blockchain scorecard messages B.SCR.MSG.

In step 14.24 the second supplier system 106 determines whether it is directed to post one or more answers to queries referenced in or specified by the query subset message SQ.MSG.001 to the blockchain instances 1300BC as stored within the blockchain servers 1302-1312. In step 14.26 the second supplier system 106 formats an exemplary subset posting message SP.MSG.001 addressed to at least one blockchain server 1302-1312 and populates the posting message with selected answers, wherein some portion of the content of the subset posting message SP.MSG.001 is digitally signed with an alternate private key of another unique private-public key pair. In step 14.28 the second supplier system 106 transmits the subset posting message SP.MSG.001 to at least one blockchain server 1302-1312.

In step 14.30 the second supplier system 106 determines whether to proceed on to alternate computational operations of step 13.32 or to participate further in operations of the first BC method. It is understood that in an alternate outcome of step 14.16 that the primary system 105 and/or the first enquirer system 111 proceed to step 14.30.

Referring now generally to the Figures and particularly to FIG. 15, FIG. 15 presents a block diagram of the exemplary first blockchain scorecard message B.SCR.MSG.001 as transmitted via the network 100 form the first enquirer system 111 to the primary system 105, wherein a network address S.ADDR.001 of the primary system 105 is applied as a destination address, a network address BP.ADDR.001 of the first enquirer system 111 is applied as a sender address and a plurality of question identifiers Q.ID.001-Q.ID.N with associated question text Q.TXT.001-Q.TXT.N are specified. In addition and optionally, a first scorecard identifier SCR.ID.001 and a first blockchain message identifier is included in the first blockchain scorecard message B.SCR.MSG.001.

One or more question identifiers Q.ID.001-Q.ID.N may be further associated by inclusion in the first blockchain scorecard message B.SCR.MSG.001 with a positive post flag PFlag+ or a negative post flag PFlag− that alternately instruct a supplier system 105-110 to post or not post relevant answers to the blockchain 1300BC, and/or instruct a supplier system 105-110 to issue replies messages R.MSG.001-R.MSG.N to relevant answers. In the way of the clarifying and not limiting exemplary first blockchain scorecard message B.SCR.MSG.001, an instruction to post answers related to the certain question identifiers Q.ID.001 & Q.003-Q.N to the blockchain 1300BC is provided by association with the positive post flag PFlag+. Alternatively, an instruction to not post an answer related to the second question identifiers Q.ID.002 to the blockchain 1300BC is provided by association with the negative post flag PFlag−. Optionally or additionally, the first blockchain scorecard message B.SCR.MSG.001 contains an instruction to issue a reply message to answers related to the certain question identifiers Q.ID.001 Q.ID.002 & Q.ID.003 to the first enquirer system 111 is provided by association with the positive reply flag RFlag+. Alternatively, an instruction to not issue a reply message containing an answer related to another question identifiers Q.ID.004, Q.ID.005 & Q.ID.N to the first enquirer system 111 is provided by association with the negative reply flag RFlag-.

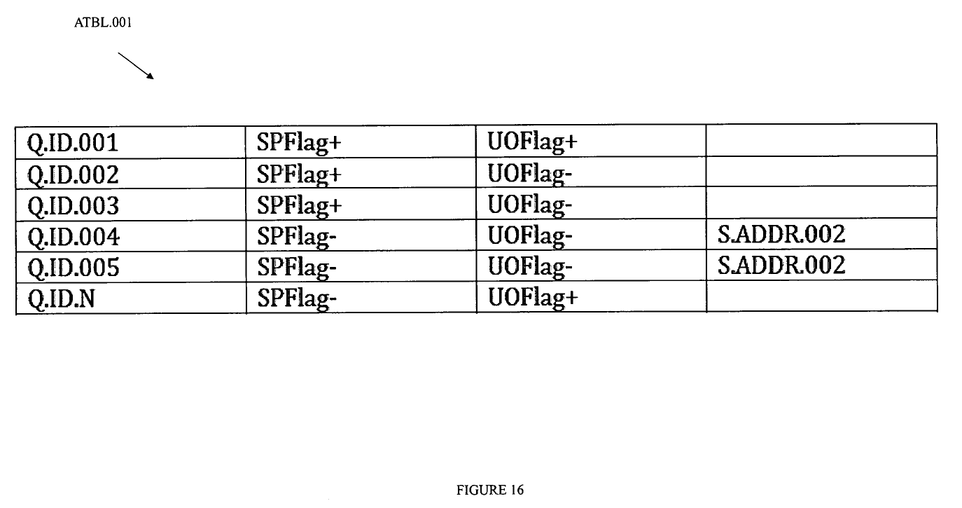

Referring now generally to the Figures and particularly to FIG. 16, FIG. 16 is a block diagram of an exemplary first authorization table ATBL.001 of the primary system 105 that contains optional information provided and applied in certain alternate preferred embodiments of the invented block chain method, wherein a listing of question identifiers Q.ID.001-Q.ID.N optionally includes alternate and additional instructions to (a.) automatically post an answer to a question of a specified question identifier Q.ID.001-Q.ID.003 to the blockchain 1300B, (b.) not automatically post an answer to a question of a specified Q.ID.004-Q.ID.N to the blockchain 1300BC, and/or (c.) a user override authorization flag UOFlag+ that enables either another process or a human user of the primary system 105 to disregard or override the instruction of the first authorization table ATBL.001 to post or not post an answer associated with a specified question identifiers Q.ID.001 & Q.ID.N to the blockchain 1300BC.

An optional negative user override authorization flag UOFlag− indicates that the user is not enabled by the primary system 105 to disregard or override the instruction of the first authorization table ATBL.001 to post or not post an answer associated with a specified question identifiers Q.ID.001 & Q.ID.N to the blockchain 1300BC. In the first authorization table ATBL.001 the negative user override authorization flag UOFlag− is associated with question identifiers Q.ID.02-Q.ID.5.

More particularly, the first authorization table ATBL.001 instructs the primary system 105 to automatically post to the blockchain 1300BC answers associated with question identifiers Q.ID.001, Q.ID.002 & Q.ID.003 by associating a positive supplier post flag SPFlag+ with question identifiers Q.ID.001, Q.ID.002 & Q.ID.003. Additionally, the first authorization table ATBL.001 further instructs the primary system 105 to not automatically post to the blockchain 1300BC answers associated with question identifiers Q.ID.004, Q.ID.005 & Q.ID.N by associating a negative supplier post flag SPFlag− with question identifiers Q.ID.004, Q.ID.005 & Q.ID.N.

The first authorization table ATBL.001 yet further instructs the primary system 105 to enable another process or a human user of the primary system 105 to disregard certain negative post flags SPFlag− and positive post flags SPFlag+ of the first authorization table ATBL.001 and to enable the other information technology process or a human user of the primary system 105 to direct the primary system 105 to post or not post an answer associated with a specified question identifier Q.ID.001& Q.ID.N to the blockchain 1300BC by association of the specified question identifiers Q.ID.001& Q.ID.N with a positive user override authorization flag UOFlag+. Alternatively, an association of a negative user override authorization flag UOFlag− with other specified question identifiers Q.ID.002-Q.ID.005 fails to authorize the other information technology process or a human user to override any negative post flag SPFlag− or positive post flag SPFlag+ of the first authorization table ATBL.001.

The first authorization table ATBL.001 yet further instructs the primary system 105 to forward on to a specified network address of another supplier system 105-110 answers to certain selected questions of specified question identifiers Q.ID.001-Q.ID.N. In the exemplary first authorization table ATBL.001 of the primary system 105, the question identifiers Q.ID.004 & Q.ID.005 are associated with a network address S.ADDR.002 of the second supplier system 106, whereby the primary system 105 is instructed to forward on the questions associated with the fourth question identifier Q.ID.004 and the fifth question identifier Q.ID.005 to the second supplier system 106 at the associated second supplier system network address S.ADDR.002 in the exemplary first query subset message SQ.MSG.001. Preferably, all other information and instructions of the blockchain scorecard message B.SCR.MSG and applicable to the fourth question identifier Q.ID.004 and the fifth question identifier Q.ID.005 are included in the first query subset message SQ.MSG.001.

In application of the first authorization table ATBL.001 to the first blockchain scorecard message B.SCR.MSG.001 in step 14.06, the primary system 105 would read the first blockchain scorecard message B.SCR.MSG.001 and determine that the first blockchain scorecard message B.SCR.MSG.001 instructs the primary system 105 to transmit a reply message containing answers to questions associated with the first, second and third question identifiers Q.ID.001, Q.ID.002 & Q.003. The primary system 105 would then in step 14.08 format, populate and transmit an electronic message via the network 100 containing answers to questions associated with the first, second and third question identifiers Q.ID.001, Q.ID.002 & Q.003.

In application of the first authorization table ATBL.001 to the first blockchain scorecard message B.SCR.MSG.001 in step 14.10, the primary system 105 would read the first blockchain scorecard message B.SCR.MSG.001 and determine that the first blockchain scorecard message B.SCR.MSG.001 instructs the primary system 105 to post to the blockchain 1300BC answers to questions associated with the first, and third through Nth question identifiers Q.ID.001 & Q.ID.004-Q.ID.N. However, the primary system 105 would be instructed by the first authorization table ATBL.001 to not automatically post answers to the blockchain 1300BC to questions related to question identifiers Q.ID.004 through Q.N to the blockchain 1300BC. This instruction to prohibit an instruction to post a related answer to the blockchain 1300BC is effected by an association of each of the question identifiers Q.ID.004 through Q.ID.N with the negative supplier post flag SPFlag−. It is noted that the nth question identifier is associated with a positive user override flag UOFlag+, which would instruct the primary system 105 to allow a user or other authorized information technology process to ignore the posting prohibition of the negative post flag SPFlag− if so directed by the user or an authorized information technology process.

The primary system 105 would then in step 14.12 format and populate an exemplary first blockchain post message P.MSG.001 that would be addressed to at least one blockchain server 1302-1312 and would contain the first and third question identifiers Q.ID.001 & Q.ID.003 and associated answers. The primary system 105 would optionally additionally include the nth question identifier Q.ID.N and associated answer if instructed to do so by a human user or an authorized information technology process. The primary system 105 would then transmit the first blockchain posting message P.MSG.001 to one or more blockchain servers 1302-1312 in step 14.14.

In a continued application of the first blockchain scorecard message B.SCR.MSG.001 to the first authorization table ATBL.001 by the primary system 105 in step 14.16, the primary system 105 determines in step 14.16 that the information of the first blockchain scorecard message B.SCR.MSG.001 related to the fourth and fifth question identifier shall be forwarded in step 14.18 on to the second supplier system network address S.ADDR.002 of the second supplier system 106. The second supplier 106 upon receipt of the information of the first blockchain scorecard message B.SCR.MSG.001 related to the fourth and fifth question identifiers Q.ID.004 & Q.ID.005 executes the loop of steps 14.20 through 14.30 and might elect to (a.) issue an electronic reply message containing an answer related to the fifth question identifier Q.ID.005 in step 14.11 (b.) post answers related to the fourth and fifth question identifiers Q.ID.004 & Q.ID.005 to the blockchain 1300BC in step 14.28.

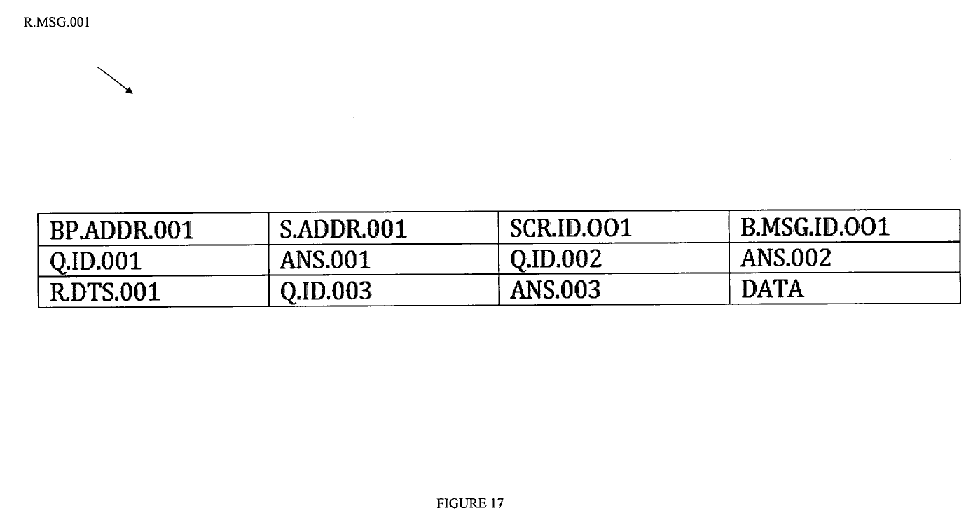

Referring now generally to the Figures and particularly FIG. 17, FIG. 17 is a block diagram of a first reply message R.MSG.001 as generated by the primary system 105 in step 14.08 in accordance with the example of the application of the first blockchain scorecard message B.SCR.MSG.001. The first reply message R.MSG.001 includes the network address BP.ADDR.001 of the first enquirer system 111 as the destination address, the network address S.ADDR.001 of the primary system 105 as the sender address, the first score card identifier SCR.ID.001, the first blockchain message identifier B.MSG.ID.001, the first question identifier Q.ID.001, a first question answer ANS.001 as supplied by the primary system 105, the second question identifier Q.ID.002, a second question answer ANS.002 as supplied by the primary system 105, the third question identifier Q.ID.003, a third question answer ANS.003 as supplied by the primary system 105, a first reply message date time stamp R.DTS.001 of the generation of the instant first reply message R.MSG.001 as generated by the primary system 105, and optionally additional data as supplied by the primary system 105.

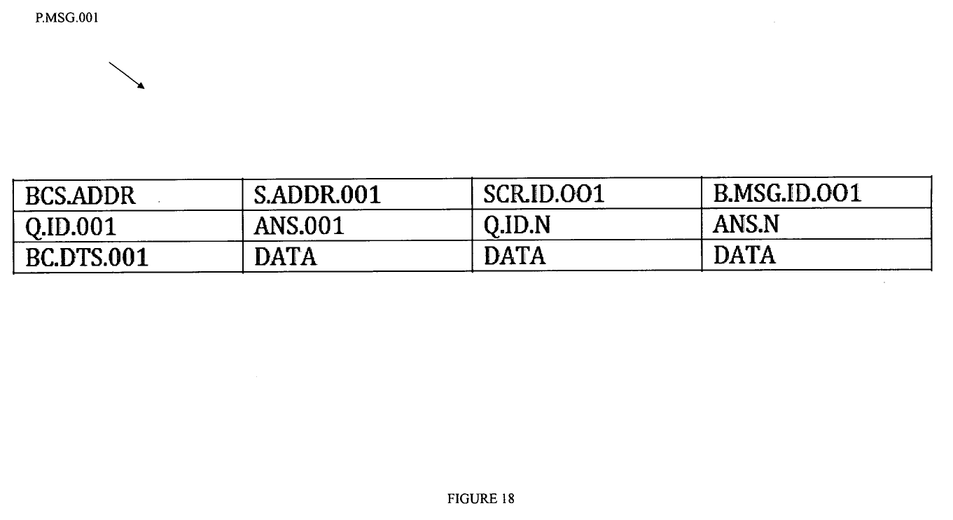

Referring now generally to the Figures and particularly FIG. 18, FIG. 18 is a block diagram of a first blockchain post message P.MSG.001 as generated by the primary system 105 in step 14.12 of the method of FIG. 14. The first blockchain post message P.MSG.001 includes a network address BCS.ADDR of a blockchain server 1302-1312 as the destination address, the network address S.ADDR.001 of the primary system 105 as the sender address, the first score card identifier SCR.ID.001, the first blockchain message identifier B.MSG.ID.001, the first question identifier Q.ID.001, the first question answer ANS.001 as supplied by the primary system 105, the nth question identifier Q.ID.N, an nth answer ANS.N to nth question text Q.TXT.N as supplied by the primary system 105, a first blockchain post message date time stamp BC.DTS.001 of the generation of the instant first blockchain post message R.MSG.001 as generated by the primary system 105, and optionally additional data as supplied by the primary system 105.

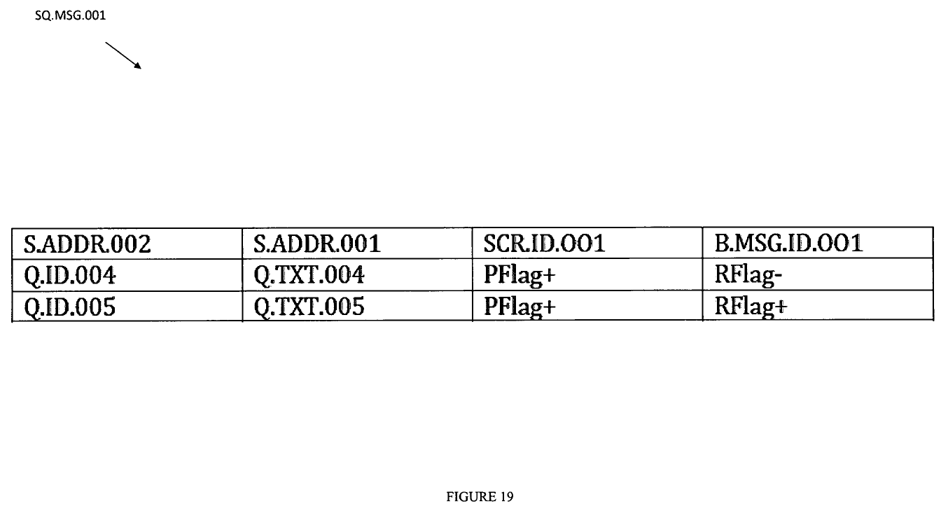

Referring now generally to the Figures and particularly FIG. 19, FIG. 19 is a block diagram of a first subset query message SQ.MSG.001 as generated by the primary system 105 in step 14.18 of the method of FIG. 14. The first subset query message SQ.MSG.001 includes a network address S.ADDR.002 of the supplier system A 106 as the destination address, the network address S.ADDR.001 of the primary system 105 as the sender address, the first score card identifier SCR.ID.001, the first blockchain message identifier B.MSG.ID.001, the fourth question identifier Q.ID.004, the fourth question text Q.TXT.004, a positive post associated with the fourth question identifier Q.ID.004, a negative reply flag RFlag− associated with the fourth question identifier Q.ID.004, the fifth question identifier Q.ID.005, the fifth question text Q.TXT.005, a positive post flag PFlag+ associated with the fifth question identifier Q.ID.005, and a positive reply flag RFlag+ associated with the fifth question identifier Q.ID.005.

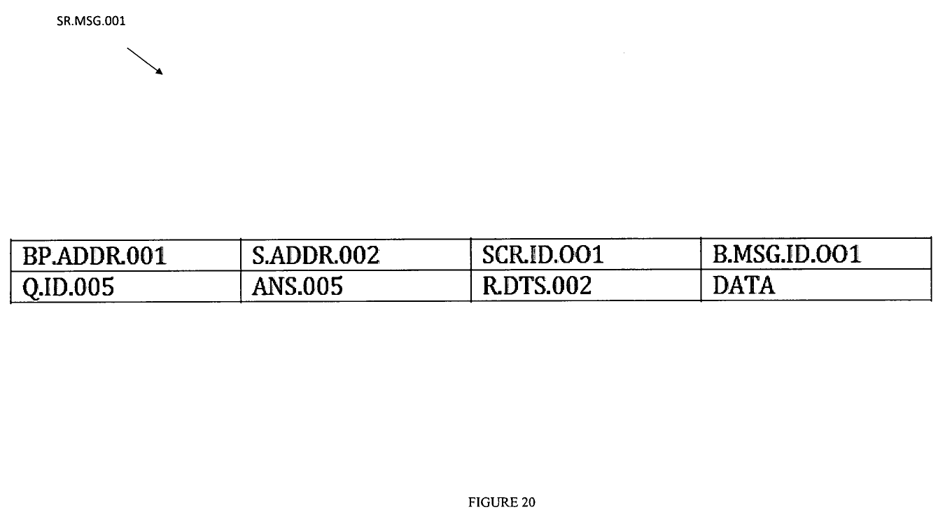

Referring now generally to the Figures and particularly FIG. 20, FIG. 20 is a block diagram of a first query subset reply message SR.MSG.001 as generated by the supplier system A 106 in step 14.22 of the method of FIG. 14. The first query subset reply message SR.MSG.001. The first query subset reply message SR.MSG.001 includes the network address BP.ADDR.001 of the first enquirer system 111 as the destination address, the network address S.ADDR.002 of the supplier system 106 as the sender address, the first score card identifier SCR.ID.001, the first blockchain message identifier B.MSG.ID.001, the fifth question identifier Q.ID.005, a fifth question answer ANS.005 as supplied by the supplier system A 106, a second reply message date time stamp R.DTS.002 of the generation of the instant first query subset reply message SR.MSG.001 as generated by the supplier system A 106, and optionally additional data as supplied by the supplier system A 106.

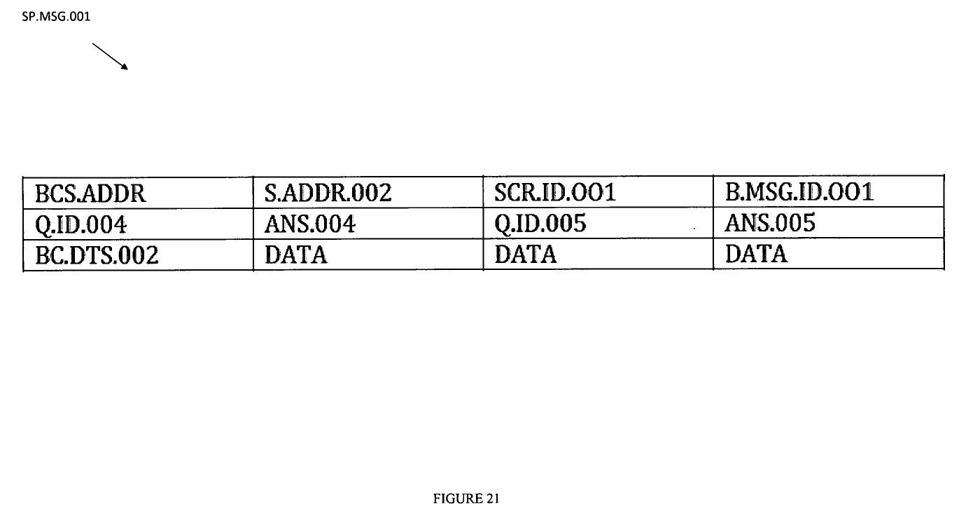

FIG. 21 is a block diagram of a first subset blockchain post message SP.MSG.001 as generated by the supplier system A 106 in step 14.26 of the method of FIG. 14. The first subset blockchain post message SP.MSG.001 includes a network address BCS.ADDR of a blockchain server 1302-1312 as the destination address, the network address S.ADDR.002 of the supplier system A 106 as the sender address, the first score card identifier SCR.ID.001, the first blockchain message identifier B.MSG.ID.001, the fourth question identifier Q.ID.004, the fourth question answer ANS.004 as supplied by the supplier system A 106, the 5th question identifier Q.ID.005, a fourth question answer ANS.004 as supplied by the supplier system A 106, a second blockchain post message date time stamp BC.DTS.002 of the generation of the instant first subset blockchain post message SP.MSG.001 as generated by the supplier system A 106, and optionally additional data as supplied by the supplier system A 106.

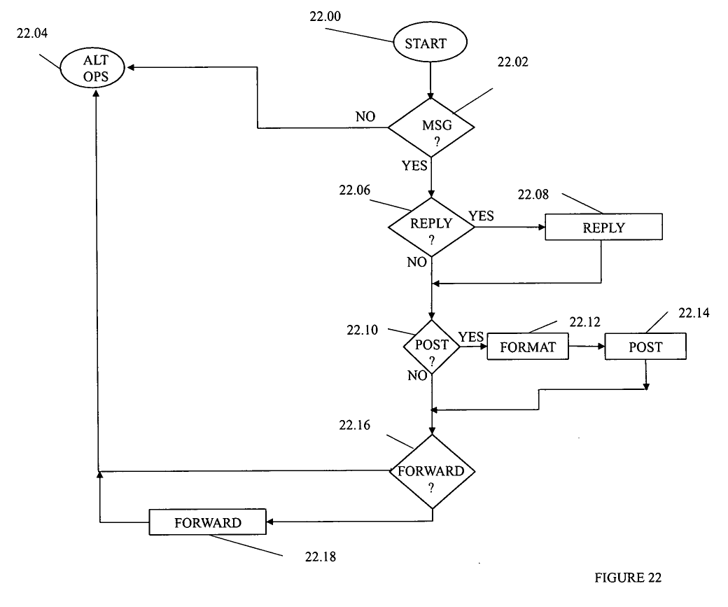

Referring now generally to the FIGURES and particularly to FIG. 22 is a flowchart of operations of a supplier system 105-110 in responding to and processing a blockchain scorecard message. For the purposes of clarity of explanation and not offered as limitation, the exemplary supplier system A 106 will be referenced as an exemplary supplier system 105-110 executing the aspects of the method of FIG. 22. In step 22 the supplier system A 106 powers and boots up and initiates or renews bi-directional communications with the network 100. The supplier system A 106 determines in step 22.02 whether it has newly received a blockchain scorecard message B.SCR.MSG.002-B.SCR.MSG.N via the network 100, and proceeds on to step 22.04 to perform alternate computational operations. In the alternative, when the supplier system A 106 has determined that a blockchain scorecard message blockchain scorecard message B.SCR.MSG.001-B.SCR.MSG.N has been received, the supplier system A 106 proceeds onto step 22.06 and determines whether the received blockchain scorecard message B.SCR.MSG.002-B.SCR.MSG.N instructs the supplier system A 106 to transmit and reply messages. When the supplier system A 106 determines in step 22.06 to have the received instructions in the blockchain scorecard message B.SCR.MSG.002-B.SCR.MSG.N detected in step 23.02, the supplier system A 106 proceeds on to step 22.08 and to generate and transmit via the network 100 one or more reply messages R.MSG.001-R.MSG.N & SR.MSG.001-SR.MSG.N in accordance with the instructions of the instant blockchain scorecard message B.SCR.MSG.002-B.SCR.MSG.N.

The supplier system A 106 proceeds on from either step 22.06 or step 22.08 to step 22.10 and to determine whether the received blockchain scorecard message B.SCR.MSG.002-B.SCR.MSG.N instructs the supplier system A 106 to post any information to the blockchain 1300BC. When the supplier system A 106 determines that the blockchain scorecard message B.SCR.MSG.002-B.SCR.MSG.N instructs the supplier system A 106 to post information to the blockchain 1300BC, the supplier system A 106 formats, populates, and signs selected data with a private key of a private-public key pair previously assigned to either the supplier system A 106 or to a persistent identifier to a posting message P.MSG.002-P.MSG.N. The supplier system A 106 then communicates, i.e., posts, the newly generated posting message P.MSG.002-P.MSG.N via the network 100 to at least one blockchain server 1302-1312 in step 22.14.

The supplier system A 106 proceeds from either step 22.10 or step 22.14 to step to determine if any query information of the instant blockchain scorecard message SCR.MSG.002-B.SCR.MSG.N shall be forwarded on for processing to another supplier system 105, 108 & 110. When the supplier system A 106 determines in step 22.16 query at least some of information of the blockchain scorecard message SCR.MSG.002-B.SCR.MSG.N shall be forwarded on for processing to another supplier system 105, 108 & 110, the supplier system A 106 proceeds on to step 22.18 and generates a subset query message SQ.MSG.002-SQ.MSG.001.N containing said selected information with related instructions, e.g., instructions to post answers ANS.001-ANS.N to queries to the blockchain 1300BC and/or issue a reply message that include answers ANS.001-ANS.N to queries. The supplier system A 106 proceeds from either step 22.16 or step 22.18 to step 22.04 and to perform alternate computational operations that may include returning to an additional execution of step 22.02.

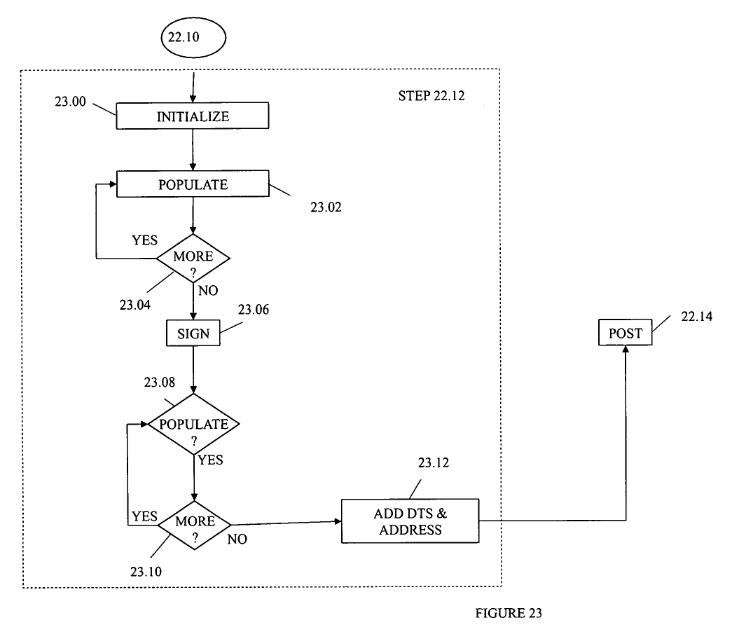

FIG. 23 is a flowchart of additional optional operations of step 22.12 of a supplier system 105-110 in preparing a blockchain posting message P.MSG.001-P.MSG.N. For the purposes of clarity of explanation and not offered as limitation, the exemplary supplier system A 106 will be referenced as an exemplary supplier system 105-110 and executing the aspects of the method of FIG. 22 to generate an exemplary second posting message P.MSG.002. In step 23.00 the supplier system A 106 initializes the second posting message P.MSG.002, to include adding at least one network address of a blockchain server 1302-1312 as a destination address. In the loop of steps 23.02 and 23.04 the supplier system A 106 adds information, e.g., one or more answers ANS.001-ANS.N, that is intended to be signed by the private key of the public-private key pair that is at least currently associated with the supplier system A 106. In step 23.06 the supplier system A 106 signs the information added to the second posting message P.MSG.002 in one or more executions of step 23.02 with private referenced in the discussion of loop of steps 23.02 and 23.04

The supplier system A 106 proceeds on to the loop of steps 23.08 and 23.10 and to add additional information to the second posting message P.MSG.002 that is not intended to be digitally signed. In step 23.12 a third date time stamp BC.DTS.003 indicating time of communication of the second posting message P.MSG.002 is added to the second posting message P.MSG.002 and other information, such as a supplier identifier or a network address of the supplier system A 106 as a sender address, or a second blockchain scorecard message identifier B.SCR.MSG.ID.002 of a second blockchain scorecard message B.SCR.MSG.002 from which the instant posting message P.MSG.002 was derived. The subsequent posting of the second blockchain scorecard message identifier B.SCR.MSG.ID.002 of the second blockchain scorecard message B.SCR.MSG.002 in the blockchain 1300BC enables any information associated with the second blockchain scorecard message identifier B.SCR.MSG.ID.002 to be associated in a search and access of the blockchain 1300BC.

The supplier system A 106 proceeds on from step 23.12 and to execute step 22.14.

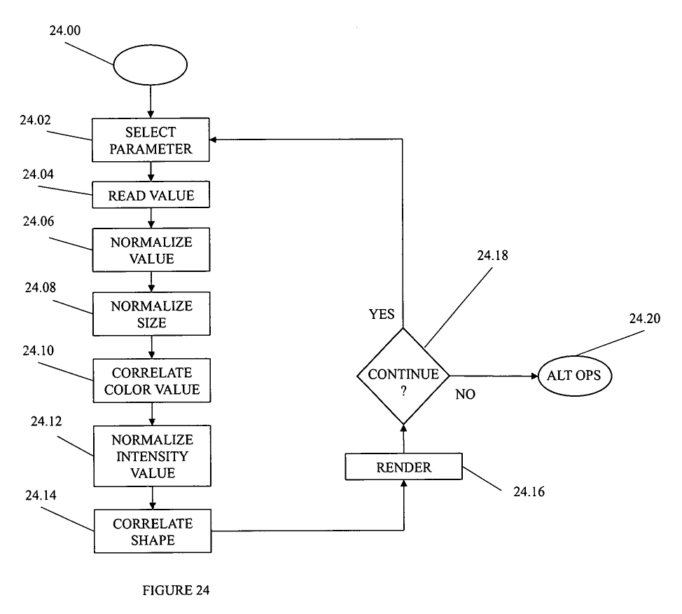

FIG. 24 is a flowchart of optional aspects of preparing a data visualization in accordance with the invented blockchain method. For the purposes of clarity of explanation and not offered as limitation, the exemplary first enquirer system 111 will be referenced as a rendering system and executing the aspects of the method of FIG. 24 to selectively render an image of a parametric value on a display screen. In step 24.00 the first enquirer system 111 powers up and boots up. In step 24.02 the first enquirer system 111 selects or is instructed to select a parameter and in step 24.04 reads a value (hereinafter, “the value”) of the parameter selected in step 24.02. In step 24.06 the value is normalized by the first enquirer system 111 to allow a determination a relative magnitude of the value in view of pre-established rendering ranges and equations. In step 24.08 the normalized value is applied by the first enquirer system 111 to a sizing process to determine a image size-value that shall represent the value on the display screen. In step 24.10 the normalized value is applied by the first enquirer system 111 to a color-value assignment process to determine the color of image that shall represent the value on the display screen. In step 24.12 the normalized value is applied by the first enquirer system 111 to a rendering energy determination assignment process to calculate a visual intensity-value that shall be applied on the display screen to render the value. In step 24.10 the normalized value is applied by the first enquirer system 111 to a shape assignment process to determine an icon shape that shall represent the value on the display screen.

In step 24.16 the determinations of step 24.08 through 24.14 are supplied to a display module of the first enquirer system 111 and the display screen of the display module visually renders the value in accordance with the determined image size-value of step 24.08, the color of step 24.10, the visual intensity-value of step 24.12 and the icon shape of step 24.14. The first enquirer system 111 determines in step 24.18 whether to proceed back to a following execution of step 24.02 or to proceed on to perform alternate computational operations in step 24.20.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a non-transitory computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based herein. Accordingly, the disclosure of the embodiments of the invention is intended to be illustrative, but not limiting, of the scope of the invention, which is set forth in the following claims.

We claim:

1. In an electronic communications network (“network”), a method comprising:
a. receiving a plurality of associated queries that include at least a first query and a second query;
b. selectively posting a first answer corresponding to the first query to a blockchain via the network; and
c. selectively replying with a second answer corresponding to the second query via the network.

2. The method of claim 1, further comprising a first system receiving the plurality of associated queries via the network and additionally receiving an instruction via the network to post the first answer to the blockchain.

3. The method of claim 1, further comprising a first system receiving the plurality of associated queries via the network and additionally receiving an instruction via the network to not post the second answer to the blockchain.

4. The method of claim 3, further comprising the first system additionally receiving an instruction via the network to post the first answer to the blockchain.

5. The method of claim 1, further comprising a first system receiving the plurality of associated queries via the network and additionally receiving an instruction from a user of the first system to post the first answer to the blockchain.

6. The method of claim 1, further comprising a first system receiving the plurality of associated queries via the network and additionally receiving an instruction from a user of the first system to not post the first answer to the blockchain.

7. The method of claim 1, further comprising a first system receiving the plurality of associated queries and applying a negation list of queries, wherein the negation list includes an identification of the second query and the negation list instructs the first system to not post the second query to the blockchain.

8. The method of claim 1, further comprising a first system receiving the plurality of associated queries and the first system forwarding a third query via the electronics communications system to a second system.

9. The method of claim 8, further comprising the second system posting a third answer to the blockchain, wherein the third answer corresponds to the third query.

10. The method of claim 8, further comprising the second system not posting a third answer to the blockchain, wherein the third answer corresponds to the third query.

11. The method of claim 8, further comprising the second system receiving an instruction via the network to post the third answer to the blockchain.

12. The method of claim 8, further comprising the second system receiving an instruction via the network to not post the third answer to the blockchain.

13. The method of claim 8, further comprising the second system applying a posting list of queries, wherein the posting list includes an identification of the third query and the posting list instructs the first system to automatically post the third answer to the blockchain.

14. The method of claim 8, further comprising the second system applying a negation list of queries, wherein the negation list includes an identification of the third query and the negation list instructs the second system to not post the third answer to the blockchain.

15. A device, the device bi-directionally communicatively coupled with an electronic communications network (“network”), and the device comprising:
a central processing unit (“CPU”) bi-directionally communicatively coupled with a network interface, the network interface bi-directionally communicatively coupled the device with the network; and
a memory bi-directionally communicatively coupled with the CPU, and the memory containing instructions that operatively direct the device to:
a. receive a plurality of associated queries that include at least a first query and a second query;
b. selectively transmit a blockchain message via the network to post a first answer corresponding to the first query to a blockchain; and
c. selectively transmit a reply message via the network containing a second answer corresponding to the second query.
